(19) United States
(12) Patent Application Publication
(10) Pub. No.: US 2026/0239014 A1
(43) Pub. Date: Aug. 13, 2026

(54) TRUST EXPOSURE FUNCTION IN WIRELESS SYSTEMS

(71) Applicant: InterDigital Patent Holdings, Inc., Wilmington, DE (US)

(72) Inventors: Chonggang Wang, Princeton, NJ (US); Robert Gazda, Spring City, PA (US); Xu Li, Plainsboro, NJ (US); Liangkun Yu, Conshohocken, PA (US); Samir Ferdi, Kirkland (CA); Ulises Olvera-Hernandez, Saint-Lazare (CA); Rocco Di Girolamo, Laval (CA); Michael Starsinic, Newtown, PA (US); Michel Roy, Candiac (CA); Catalina Mladin, Hatboro, PA (US)

(73) Assignee: InterDigital Patent Holdings, Inc., Wilmington, DE (US)

(21) Appl. No.: 19/049,679

(22) Filed: Feb. 10, 2025

(51) Int. Cl. H04W 12/60; H04W 8/22; H04W 48/02; H04W 84/04

(52) U.S. Cl. CPC H04W 12/66; H04W 8/22; H04W 48/02; H04W 84/042

(57) ABSTRACT

Methods and apparatuses are provided for trust exposure in a wireless communication system. A wireless transmit/receive unit (WTRU) may indicate a WTRU trust capability to a trust management function (TMF). The WTRU may create one or more WTRU trust information exposure policies and/or transmit the one or more WTRU trust information exposure policies to the TMF. The WTRU may transmit an application request to an application server (AS). The WTRU may receive a trust information exposure request from the TMF. The WTRU may approve the trust information exposure request. The WTRU may transmit a trust information exposure response to the TMF. The WTRU may receive a trust information exposure notification from the TMF. The WTRU may receive an application response from the AS.

### BACKGROUND

In wireless communication networks, ensuring trust and security is a challenge, especially when a wireless transmit/receive unit (WTRU) interacts with an external domain. For instance, a trust status of the external domain may be unknown and/or unverified. Therefore, trust information of the WTRU cannot be securely shared with the external domain. For applications that require the trust information to be shared with the external domain, an explicit consent from the WTRU and/or one or more users of the WTRU may be required. However, the WTRU and/or the one or more users of the WTRU may not always be available. Additionally, requesting consent from the WTRU multiple times may negatively impact performance of the WTRU and/or user experience of the one or more users. For some applications, not receiving the consent may cause delays and/or failures, which may also negatively affect the performance and the user experience. Therefore, there is a need for an efficient and reliable approach to establish trust in an effective manner.

### SUMMARY

In one or more embodiments, a method performed by a wireless transmit/receive unit (WTRU) is provided. The method includes transmitting, to a first trust management function (TMF), a WTRU trust capability container indicative of one or more trust capabilities parameters. The method includes creating one or more WTRU trust information exposure policies (TINFO-EPs). The method includes transmitting the one or more TINFO-EPs to the first TMF. The method includes transmitting, to an application server (AS), an application request comprising an identifier associated with the first TMF. In an example, the identifier may be used to find the first TMF and/or to enable the communication with the first TMF. The method includes receiving, from the first TMF, a trust information exposure request in response to transmitting the application request. The method includes approving or rejecting the trust information exposure request. The method includes transmitting, to the first TMF, a trust information exposure response indicative of the approval or the rejection of the trust information exposure request.

In an embodiment, the method incudes receiving, from a second TMF associated with the AS, an AS trust index associated with the AS. The method includes comparing the AS trust index with a threshold AS trust index and/or a range of AS trust indexes. The method includes determining that the AS is trustworthy when the AS trust index exceeds the threshold AS trust index and/or is within the range of AS trust indexes. The method includes establishing a protocol data unit (PDU) session based on determination that the AS is trustworthy.

In an embodiment, the first TMF is an internal TMF (iTMF) in a current public land mobile network (PLMN). In an embodiment, the second TMF is an external TMF (eTMF) in a data network (DN) or a home PLMN.

In an embodiment, the WTRU trust capability container is transmitted using one or more of: a WTRU registration request, a service request, a PDU session establishment request, a PDU session modification request, or a dedicated trust capability indication.

In an embodiment, the method includes creating one or more new TINFO-EPs based on the trust information exposure request. The trust information exposure response is further indicative of the one or more new TINFO-EPs.

In an embodiment, the method includes receiving, from the first TMF, a trust information exposure notification indicative of updating the one or more new TINFO-EPs by the first TMF.

In an embodiment, the WTRU trust capability container is further indicative of one or more of: willingness of trust information collection and measurement, or willingness of trust information exposure;
In an embodiment, the one or more trust capabilities parameters include one or more of: a trust capability level, a trust information evaluation formula, a trust information storage period, a trust information storage size, a trust information retrieval application programming interface (API), an object of trust capability, a time limitation associated with trust information capability, a location limitation associated with the trust information capability, or a trust information exposure approval capability.

In an embodiment, the one or more TINFO-EPs are indicative of one or more of: one or more TINFO-EP application conditions, one or more allowed external requesters, one or more prohibited external requesters, one or more WTRU consent conditions, or a WTRU notification requirement.

In an embodiment, the application request is indicative of at least one of: requesting one or more services from the AS, or requesting discovery of one or more devices by the AS.

In one or more embodiments, a WTRU is provided. The WTRU includes a transceiver and a processor. The transceiver and the processor are configured to transmit, to a first TMF, a WTRU trust capability container indicative of one or more trust capabilities parameters. The transceiver and the processor are configured to create one or more WTRU TINFO-EPs. The transceiver and the processor are configured to transmit the one or more TINFO-EPs to the first TMF. The transceiver and the processor are configured to transmit, to an AS, an application request comprising an identifier associated with the first TMF. In an example, the identifier may be used to find the first TMF and/or to enable the communication with the first TMF. The transceiver and the processor are configured to receive, from the first TMF, a trust information exposure request in response to transmitting the application request. The transceiver and the processor are configured to approve or reject the trust information exposure request. The transceiver and the processor are configured to transmit, to the first TMF, a trust information exposure response indicative of the approval or the rejection of the trust information exposure request.

In an embodiment, the transceiver and the processor are configured to: receive, from a second TMF associated with the AS, an AS trust index associated with the AS. The transceiver and the processor are configured to compare the AS trust index with a threshold AS trust index and/or a range of AS trust indexes. The transceiver and the processor are configured to determine that the AS is trustworthy when the AS trust index exceeds the threshold AS trust index and/or is within the range of AS trust indexes. The transceiver and the processor are configured to establish a PDU session based on determination that the AS is trustworthy.

In an embodiment, the first TMF is an iTMF in a current PLMN. In an embodiment, the second TMF is an eTMF in a DN or a home PLMN.

In an embodiment, the WTRU trust capability container is transmitted using one or more of: a WTRU registration request, a service request, a PDU session establishment request, a PDU session modification request, or a dedicated trust capability indication.

In an embodiment, the transceiver and the processor are configured to: create one or more new TINFO-EPs based on the trust information exposure request, wherein the trust information exposure response is further indicative of the one or more new TINFO-EPs.

In an embodiment, the transceiver and the processor are configured to: receive, from the first TMF, a trust information exposure notification indicative of updating the one or more new TINFO-EPs by the first TMF.

In an embodiment, the WTRU trust capability container is further indicative of one or more of: willingness of trust information collection and measurement, or willingness of trust information exposure.

In an embodiment, the one or more trust capabilities parameters include one or more of: a trust capability level, a trust information evaluation formula, a trust information storage period, a trust information storage size, a trust information retrieval API, an object of trust capability, a time limitation associated with trust information capability, a location limitation associated with the trust information capability, or a trust information exposure approval capability.

In an embodiment, the one or more TINFO-EPs are indicative of one or more of: one or more TINFO-EP application conditions, one or more allowed external requesters, one or more prohibited external requesters, one or more WTRU consent conditions, or a WTRU notification requirement.

In an embodiment, the application request is indicative of at least one of: requesting one or more services from the AS, or requesting discovery of one or more devices by the AS.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a system diagram illustrating an example cross-domain network shown according to one or more embodiments;

FIG. 2B is a system diagram illustrating an example service flow according to one or more embodiments;

FIG. 2C is a system diagram illustrating an example service flow according to one or more embodiments;

FIG. 3 is a flow diagram illustrating an example procedure of an application server (AS) providing one or more services to a trustworthy WTRU according to one or more embodiments;

FIG. 4 is a flow diagram illustrating an example procedure illustrating a WTRU discovering other trustworthy WTRUs using an AS according to one or more embodiments;

FIG. 5A and FIG. 5B are a flow diagram illustrating an example procedure of a trust-aware protocol data unit (PDU) session establishment according to one or more embodiments;

FIG. 6 is a system diagram illustrating a trustworthy application enabler architecture according to one or more embodiments; and

FIG. 7A and FIG. 7B are a flow diagram illustrating an example procedure for requesting additional trust information according to one or more embodiments.

### DETAILED DESCRIPTION

As discussed herein, one or more abbreviations in the following (non-exhaustive) list, shown in Table 1, may be used herein.

TABLE 1

| | |
|---|---|
| 3GPP | 3^{rd} Generation Partnership Project |
| 5G | 5^{th} Generation |
| 5GC | 5G Core Network |
| 5GS | 5G System |
| 6G | 6^{th} Generation |
| 6GC | 6G Core Network |
| 6GS | 6G System |
| Addr | Address |
| AF | Application Function |
| AMF | Access and Mobility Management Function |
| AS | Application Server |
| ASP | Application Service Provider |
| AUSF | Authentication Server Function |
| DN | Data Network |
| FE | Function Entity |
| FESC | Function Entity Service Consumer |
| FESP | Function Entity Service Producer |
| GPSI | Generic Public Subscription Identifier |
| GUTI | Globally Unique Temporary Identity |
| ID | Identifier |
| LMF | Location Management Function |
| ME | Mobile Equipment |
| MNO | Mobile Network Operator |
| NAS | Non-Access Stratum |
| NEF | Network Exposure Function |
| NF | Network Function |
| NFP | Network Function Producer |
| NPN | Non-Public Network |
| NRF | Network Repository Function |
| NWDAF | Network Data Analytics Function |
| PCF | Policy Control Function |
| PDU | Protocol Data Unit |
| PLMN | Public Land Mobile Network |
| SA | Service Architecture |
| SBA | Service-Based Architecture |
| SBI | Service-Based Interface |
| SEAF | Security Anchor Function |
| SEAL | Service Enabler Architecture Layer |
| SIDF | Subscription Identifier De-concealing Function |
| SUCI | Subscription Concealed Identifier |
| TEC | Trust Enabler Client |
| TEI | Trust Evaluation Instruction |
| TES | Trust Enabler Server |
| TIDC | Trust Indicator |
| TIDX | Trust Index |
| TINFO | Trust Information |
| TMF | Trust Management Function |
| iTMF | internal Trust Management Function |
| eTMF | external Trust Management Function |
| UDM | Unified Data Management |
| UDR | Unified Data Repository |
| UDSF | Unstructured Data Storage Function |
| UE | User Equipment |
| URI | Uniform Resource Identifier |
| VAL | Vertical Application Layer |

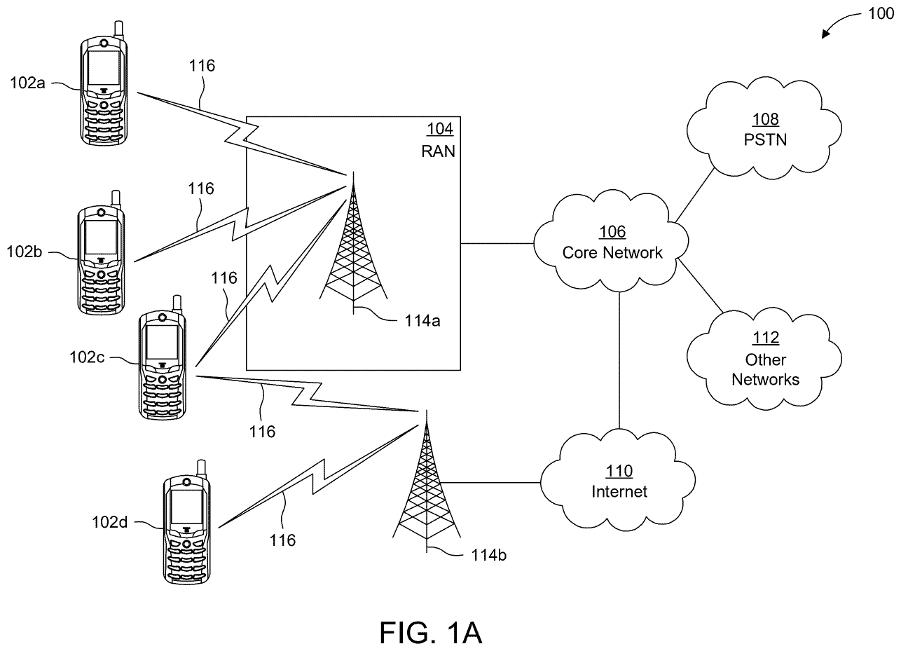

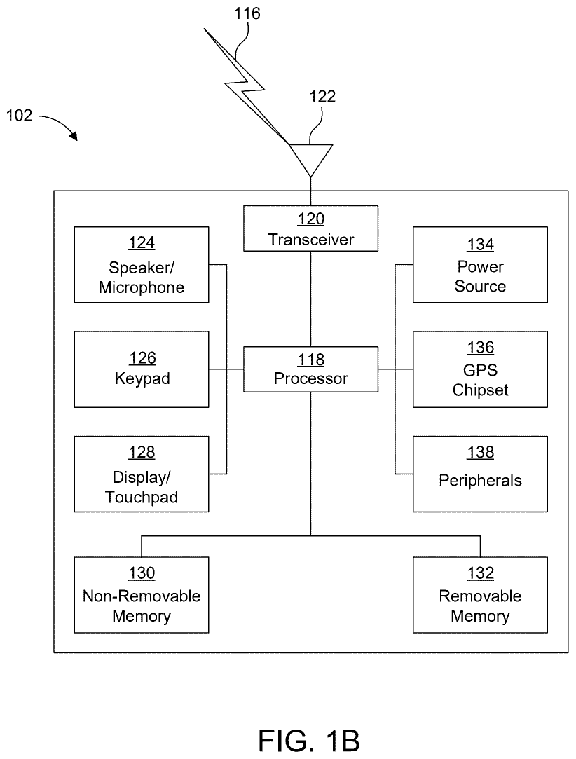

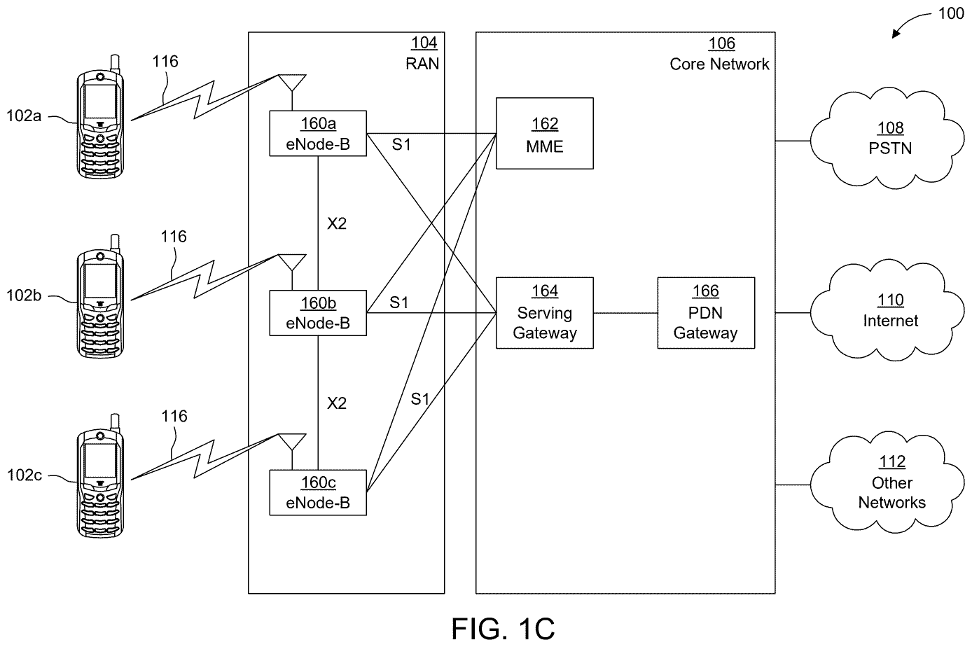

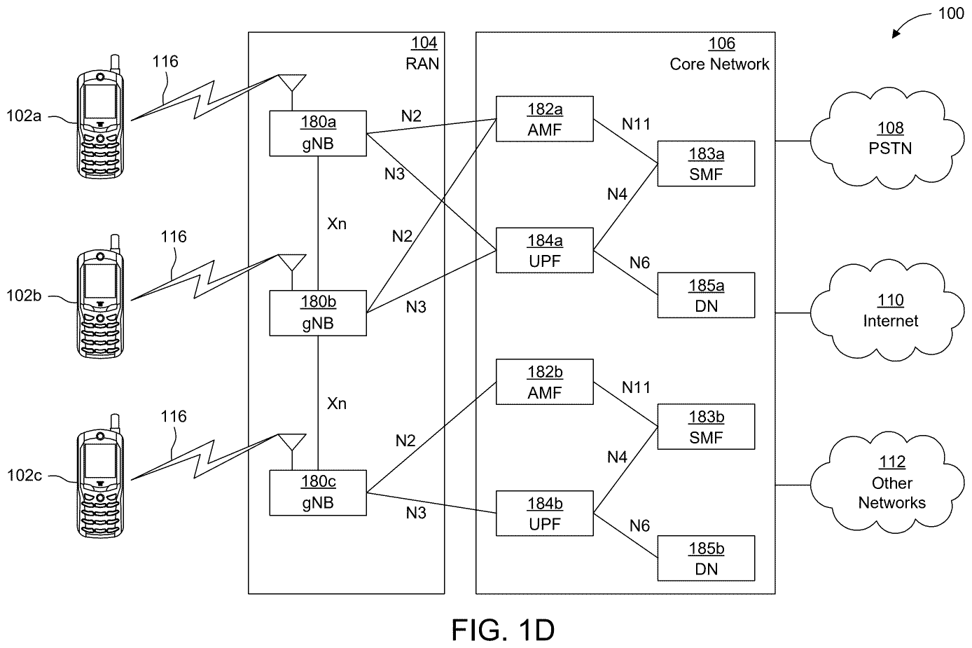

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface.

The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In various embodiments of the present disclosure, a trust exposure function is provided in various wireless systems. In various embodiments of the present disclosure, methods and apparatuses are provided for trust exposure from a third generation partnership project (3GPP) system to one or more external domains. The one or more external domains may be 3GPP external domains and/or non-3GPP external domains (e.g., Wi-Fi, satellite, and/or wireline networks etc.). In an example, one or more methods of the present disclosure may use a service layer, a service enabler layer, an application enabler layer, and/or an application layer etc. In an example, one or more methods of the present disclosure may be used in a user equipment (UE), a wireless transmit/receive unit (WTRU), one or more network functions (NFs), and/or one or more application functions (AFs). In an example, one or more methods of the present disclosure may be used in various wireless mobile networks, wireless systems, and/or wireless application systems etc.

An external domain (e.g., a data network (DN) etc.) may have a need for one or more 3GPP systems to provide trust evaluation for one or more WTRUs. A 3GPP system may need to prepare trust information of a WTRU and make the trust information available and/or accessible for the external domain to retrieve. Upon obtaining the trust information of the WTRU from the 3GPP system, the external domain can have more complete information to perform more accurate trust evaluation for the WTRU and/or for any running applications and/or functions on the WTRU.

In order for the 3GPP system to provide trust evaluation support to the external domain, there are several key issues. In one issue, exposing the trust information of the WTRU to the external domain requires a consent from the WTRU and/or one or more users of the WTRU. The WTRU might become unreachable when it is the time to expose the trust information. It might also cause a burden at the WTRU if the WTRU is contacted each time when the exposure of the trust information is requested. Therefore, there is a need to design an efficient and reliable approach that can enable trust information exposure and also guarantee the consent of the WTRU and/or the one or more users of the WTRU.

In another issue, existing secondary authentication in a protocol data unit (PDU) session establishment does not consider the trust information of the WTRU initiating the PDU session establishment. If the trust information of the WTRU can be shared with an external DN authentication, authorization, and accounting (DN-AAA) server, the DN-AAA server may leverage the trust information to realize a stronger secondary authentication and in turn may be able to assign flexible and/or customized services to the WTRU. Therefore, there is a need to efficiently expose the trust information of the WTRU from a session management function (SMF) to the DN-AAA server.

In yet another issue, one or more applications in the external domain may need to obtain trust evaluation support from the 3GPP system. Typically, although vertical applications are different, their need for trust evaluation support from the 3GPP system is in common. Therefore, there is a need for an efficient application layer functionality, which can serve and/or be leveraged by different vertical applications without each application repeatedly implementing the same functionality of their own.

In various embodiments of the present disclosure, for a WTRU engaging in new activities with and/or for a WTRU roaming to a current public land mobile network (PLMN), an internal trust management function (iTMF) of the current PLMN may provide assistance to an external TMF (eTMF). The eTMF may be a TMF of a home PLMN of the WTRU during roaming and/or an external function within the DN.

In one or more embodiments, the 3GPP domain exposes the trust information of a WTRU to a DN. One or more trust exposure policies may be configured and/or created in a core network and/or edge network for a WTRU. When an iTMF in the core network and/or in the edge network receives a request from an eTMF in a DN for accessing the trust information of the WTRU, the iTMF may leverage one or more trust exposure policies of the WTRU to flexibly and efficiently determine whether and/or how to expose the trust information to the eTMF in the DN. The WTRU may dynamically update the one or more trust exposure policies stored in the core network.

In an embodiment, an application server (AS) in a DN may need to discover one or more target WTRUs for providing one or more services to a requester WTRU. The AS may collaborate with an iTMF via an eTMF in the DN to retrieve the trust information of each target WTRU. One or more final target WTRUs being selected may be the one or more WTRUs that have respective trust indexes above a threshold trust index and/or within a preconfigured range of trust index.

In an embodiment, during PDU session establishment, the trust information of the WTRU may be shared with a DN-AAA server, which may incorporate the trust information to a secondary authentication and/or enable trust-aware authentication and/or one or more trust-aware customized services for the WTRU.

In one or more embodiments, the trust evaluation and/or the trust exposure may be used in an application enabler layer. A trust enabler client (TEC) on a WTRU and/or a trust enabler server (TES) on a DN or other networks in the application enabler layer may be configured to perform the trust evaluation and/or the trust exposure. Once requested by a vertical application server, the TES may request trust information of a WTRU from an iTMF in a fifth generation (5G) core network and/or a sixth (6G) core network, for example.

In an embodiment, a WTRU may be configured to perform one or more of the following: indicating WTRU trust capability to an iTMF; creating one or more WTRU trust information exposure policies and/or transmitting the one or more WTRU trust information exposure policies to the iTMF; transmitting an application request to an AS; receiving a trust information exposure request from the iTMF; approving the trust information exposure request; transmitting a trust information exposure response to the iTMF; receiving a trust information exposure notification from the iTMF; and/or receiving an application response from the AS etc.

In an embodiment, a TEC may be configured to perform one or more of the following: transmitting a TEC registration request to a TES; receiving a TEC registration response from the TES; receiving a trust information exposure assistance request from the TES; transmitting a trust information exposure assistance response to the TES; receiving a trust information exposure request from an iTMF; approving the trust information exposure request; transmitting a trust information exposure response to the iTMF; receiving a trust information exposure notification from the iTMF; receiving a trust index notification from the TES; and/or forwarding the trust index notification to a vertical application layer (VAL) client etc.

A 5G system architecture includes one or more WTRUs (e.g., one or more UEs), a radio access network (RAN), and a core network (CN). One of the design principles for the 5G system (5GS) is service-centric and/or service-based design. A 5G CN (5GC) follows a service-based architecture (SBA) and includes a variety of network functions (NFs), which can work together to fulfill and/or provide one or more needed services to the RAN, the one or more WTRUs, one or more application servers, and/or service providers etc. The WTRU may interact with the RAN and/or the 5GC via a non-access stratum (NAS) and an access stratum signaling.

An NF may access other NFs in request/response mode or subscription/notification mode. Before two NFs interact with each other, they first need to register with a network repository function (NRF) so that they can discover each other via the NRF. Among these NFs, access and mobility management function (AMF) manages access of a WTRU to the 5GS and mobility of the WTRU, the SMF establishes sessions between the WTRU and the 5GC, and an authentication server function (AUSF) facilitates WTRU authentication. In addition, a policy control function (PCF) provides one or more policy rules for other control plane network functions and/or WTRUs. The PCF may assign an identifier for each created policy rule, which other control plane network functions and WTRUs may use to refer to the corresponding policy rule. A user plane function (UPF) is a NF in the data plane that facilitates monitoring, managing, controlling, and/or redirecting user plane traffic flows such as between the WTRU and an application function (AF). A network exposure function (NEF) enables access to one or more 5G control plane functions to entities such as network applications and/or one or more AFs which may be outside of the 5GS and not in the same trusted domain.

Two NFs (e.g., one as a service consumer and the other as a service producer) may communicate with each other directly without any entity in the middle and/or indirectly via a service communication proxy (SCP). The SCP may forward and/or route one or more messages between the NF service consumer and the NF service producer. In addition, two NFs may interact with each other using the request/response model and/or the subscribe/notify model. In the request/response model, the NF service consumer transmits a request to the NF service producer; then, the NF service producer processes the request and transmits a response to the NF service consumer. In the subscribe/notify model, the NF service consumer first sends a subscription request to the NF service producer; then, the NF service producer processes the subscription request and stores the subscription information; whenever any subscribed event occurs, the NF service producer transmits a notification to the NF service consumer.

The 5GC also provides data storage and analytics services through functions such as a unified data management (UDM), a unified data repository (UDR), an unstructured data storage function (UDSF) and/or a network data analytics function (NWDAF), for example. Another critical feature of the 5GS is network slicing, which is facilitated by a network slice selection function (NSSF).

The 5GS includes a few NFs such as a location management function (LMF) to support various location services. The LMF may calculate, determine, and/or verify a location and/or a velocity estimation and/or may estimate an achieved accuracy, based on location information from a subject WTRU and/or a RAN node. After the LMF calculates the location of the subject WTRU, other entities may access and/or query the location from the LMF but may need to go through a serving AMF.

Although these NFs are defined as separate logical entities, a particular service scenario may require multiple NFs. For instance, the WTRU mobility may need not only the AMF, but also the AUSF and/or the SMF. Furthermore, multiple instances of same type of NF may be instantiated and the NRF may maintain the information of each instantiated network NF instance. With emergence of edge computing, some NFs in the 5GC such as the UPF and/or the NEF may be deployed and/or resided in an edge network that is much nearer to and potentially co-located with the RAN.

Existing cellular wireless systems (e.g., the 5GS) provide various security functions such as primary authentication during registration, secondary authentication during a PDU session establishment, NF service authorization, network slicing-specific authentication and authorization, network slicing admission control, and/or data plane encryption and integrity protection, etc.

The NF service authorization in the 5GS the may be a static authorization and/or a token-based authorization. In the static authorization, one or more local authorization policies are maintained at the NRF and the NF service producer. The one or more local authorization policies are used to authorize the NF service consumer, when the NF service consumer discovers the NF service producer from the NRF and/or when the NF service consumer requests to access any service from a discovered NF service producer. In token-based authorization, the NRF may grant an access token to the NF service consumer. Then, the NF service consumer may present the access token to the NF service producer, which may authorize the NF service consumer based on the access token.

In an example, in trust evaluation and/or management, a trust refers to a measurable belief that represents an accumulated value (e.g. about a quality, a behavior, a performance, a characteristic of a network node, a WTRU, a service and/or any logical and/or physical entity etc.) from history and the expected value for the future. A trust can be objective trust or subjective trust. The objective trust leverages a security mechanism, such as authentication, to validate identity of an entity. However, trust covers and is beyond security. For example, an entity passing the authentication only means the entity has successfully proved its identity, it still may not be fully trusted since the trust about the behavior and/or characteristics of the entity can still be dynamically changing and/or the criteria for evaluating the trust may also be subjective, e.g. based on user and/or personal experience and/or preference. The trust is an essential input for decision making and is usually measured or calculated based on the historical experience and/or records in the past, and the trust represents the expected value of quality, behavior, characteristics, and/or performance in the future.

A trust index may be obtained using a trust evaluation process. The trust index may be used to describe the trust of an entity. The trust index is an overall metric, which is often calculated based on the aggregation of one or more trust indicators (depending on a subjective trust evaluation criteria of a user and/or a device) using one or more trust evaluation algorithms and/or processes. The trust indicators may relate to various aspects, such as but not limited to security, privacy, resilience, performance, robustness, scalability, availability, accuracy, reliability, and/or consistency, etc. During the trust evaluation process, various data about an entity may be collected and used as one or more inputs to calculate various trust indicators, which in turn are aggregated into an overall metric, i.e. the current trust index of the entity. Trust (e.g., the trust index) may have various characteristics. For example, trust (e.g., the trust index) is dynamic, meaning that a given trust index may be applicable for a limited time period and may change as time goes on. Trust (e.g., the trust index) is also context-dependent, meaning that the trust may have a significant change if a context is changed. Trust (e.g., the trust index) is not transitive in nature, but the trust may be transitive in a few specific contexts. Similarly, trust (e.g., the trust index) is an asymmetric relationship, meaning that a fact of entity A trusting entity B cannot deduce that entity B also trusts entity A. In addition, trust (e.g., the trust index) may also be subjective, meaning that for the same entity, different users may have different criteria, opinions, and/or preferences regarding how to evaluate the trust of the entity and what kinds of trust-related aspects and/or indicators may be considered, etc., for example.

Trust generation, trust evaluation, trust assessment, trust measurement, trust computation and trust calculation may be used interchangeably in this disclosure unless there is an explicit clarification. Trust index generation, trust index evaluation, trust index assessment, trust index measurement, trust index computation and trust index calculation may be used interchangeably in this disclosure unless there is an explicit clarification.

In future wireless systems, each device may serve as a convergence point for both communication and computation. A user may access services from a network function or an external application function and, simultaneously, provide services to these entities. These services may include NWDAF, artificial intelligence (AI) as a Service (AaaS), computation as a service (CaaS), and/or sensing as a service (SaaS) etc.

One or more dynamic user and/or WTRU behaviors, such as moving from one wireless network to another, along with diverse inter-domain service combinations, create a need for enhanced trustworthiness. In such scenarios, one or more trust metrics or trust information collected in one domain must be shared with other domains to collectively determine the overall trustworthiness for a user, a device, a WTRU, an NF, an AF, and/or a service etc., for example.

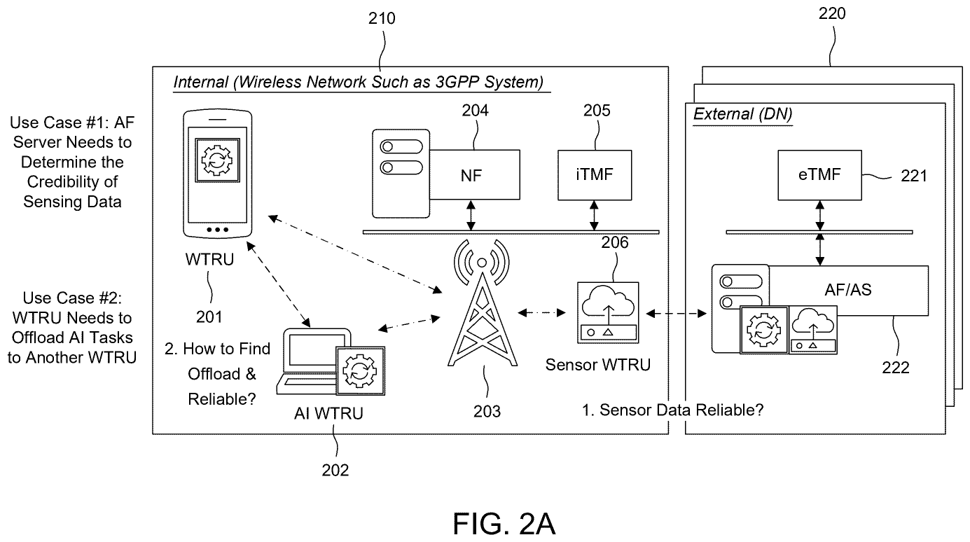

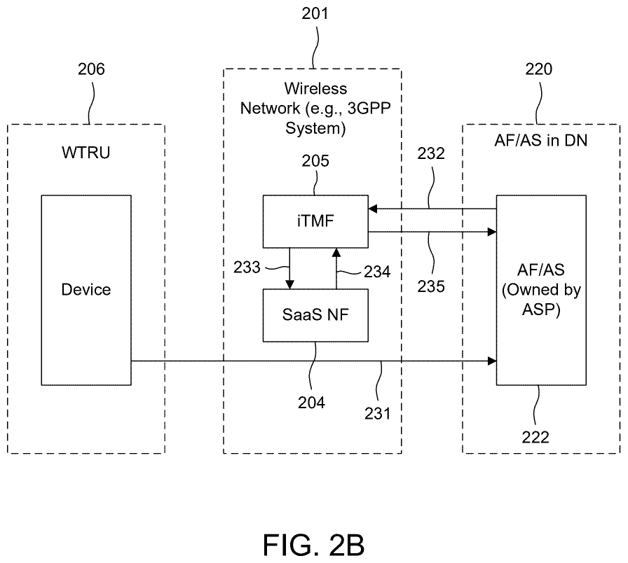

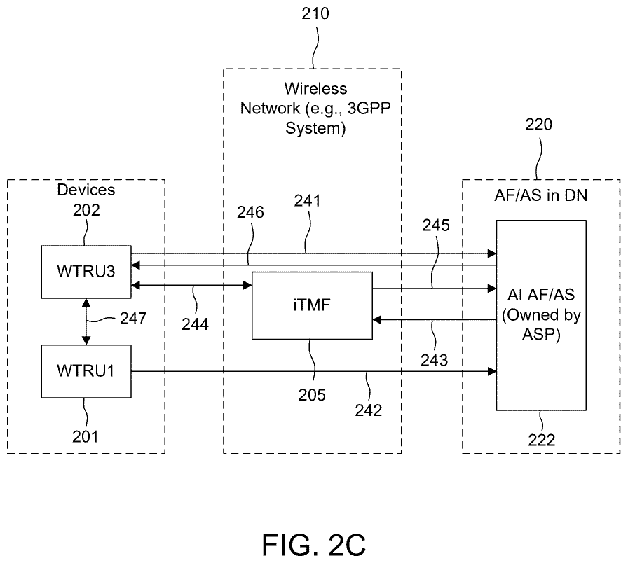

Referring now to FIG. 2A, an example cross-domain network is shown according to one or more embodiments. The cross-domain network may include an internal domain 210 and an external domain such as a DN 220. The internal domain 210 may include a WTRU 201, an AI WTRU 202, a base station 203, an NF 204, an iTMF 205, and a sensor WTRU 206. The DN 220 may include an eTMF 221 and an AF/AS 222.

In an example, the AF/AS 222 (e.g. deployed by an application service provider (ASP)) residing in the DN 220 may gather sensing data (for e.g., one or more temperature readings) from the sensor WTRU 206 located in a location (e.g., a forest), through a wireless network. In an example, if an unexpected increase in temperature raises concerns about reliability of the sensing data, the AF/AS 222 may request a credibility check by leveraging the sensing-as-a-service NF (e.g., the NF 204) and the iTMF 205 of a wireless system such as a 3GPP system (e.g., the internal domain 210).

Referring now to FIG. 2B, an example service flow is shown according to one or more embodiments. At 231, the AF/AS 222 (owned by the ASP) may collect the sensing data from a crowdsourcing temperature sensor (e.g., the sensor WTRU 206) deployed in the forest via a wireless network such as the 3GPP system (e.g., the internal domain 210). In an example, the temperature sensor (e.g., the sensor WTRU 206) may not belong to the ASP. An abnormality in the sensing data, e.g., peculiar data (e.g. abnormally high temperature) may raise concerns of the AF/AS 222 for credibility of the sensing data.

At 232, the AF/AS 222 may request the iTMF 205 in the 3GPP system (e.g., the internal domain 210) for verification of the credibility of the sensing data.

At 233, the iTMF 205 in the 3GPP system (e.g., the internal domain 210) may verify the credibility (e.g., trustworthiness) of the sensing data with the SaaS NF (e.g., the NF 204), which has access to surrounding data for comparison and analysis.

At 234, the SaaS NF (e.g., the NF 204) may return (e.g., determine and/or provide) the trustworthiness of the sensing data to the iTMF 205 of the 3GPP system (e.g., the internal domain 210).

At 235, the iTMF 205 may finalize the trustworthiness evaluation and send the result to the AF/AS 222 in the DN 220. Based on the evaluation, the AF/AS 222 may determine how to handle the anomalous sensing data, which may involve rejecting utilizing the sensing data.

In an example, the AF/AS 222 in the DN 220 (i.e., the external domain) may need the support from the 3GPP system (i.e., the internal domain 210) to determine the trustworthiness of the sensing data (e.g., the temperature sensing data). The DN 220 (e.g., the external domain) may request trust support from the 3GPP system (e.g., the internal domain 210).

Referring now to FIG. 2C, an example service flow is shown according to one or more embodiments. The WTRU 201 may seek to offload an AI training task to a nearby capable device (e.g., the AI WTRU 202) through an AI Application Server (AS) (such as an AI AS/AF 222) owned by the ASP. The AI AS/AF 222 may collaborate with the iTMF 205 in the 3GPP system (e.g., the internal domain 210) to find a trustworthy AI WTRU for the WTRU 201.

At 241, the AI WTRU 202 is registered with the AI AS/AF 222 as an entity that can execute an AI task and provide AI services to other WTRUs or other entities.

At 242, a user on the WTRU 201 opens an AI app on her phone, connecting to the AI AS/AF 222.

At 243, the AI AS/AF 222 authenticates and authorizes the user (e.g., based on her username and password). The AI AS/AF 222 chooses multiple devices (e.g., the AI WTRU 202) as candidates to provide one or more AI services for the user. However, the AI AS/AF 222 needs to contact the iTMF 205 in the 3GPP system (e.g., the internal domain 210) to assess the trustworthiness of the device candidates (e.g. the AI WTRU 202) in order to decide whether the device has sufficient trustworthiness for provisioning the one or more desired AI services.

At 244, the iTMF 205 may send a request to the AI WTRU 202 for its consent on trust information exposure.

At 245, the iTMF evaluates (and/or re-evaluates) the trustworthiness of the AI WTRU 202 (e.g., based on the AI WTRU 202 behavior information and third-party assessment). Then, the iTMF 205 provides the trustworthiness of the AI WTRU 202 to the AI AS/AF 222.

At 246, upon receiving the trustworthiness assessment from the iTMF 205, the AI AS/AF 222 instructs the AI WTRU 202 to provide the one or more AI services to the WTRU 201.

At 247, the AI WTRU 202 begins delivering the one or more AI services to the WTRU 201.

In this case, the DN 220 needs the assistance from the 3GPP system (e.g., the internal domain 210) to determine the trustworthiness of suitable offloading candidates (i.e., the WTRUs).

Both FIG. 2B and FIG. 2C show that the external domain (e.g., the DN 220 and/or the AS/AF 222 and/or the ASP) needs the wireless network (e.g., the 3GPP system i.e. the internal domain 210) to provide trust-related help (including but not limited to trust evaluation, trust-related information and/or assessment on the WTRUs, etc.).

In many embodiments, the wireless network prepares the trust information of the WTRU and makes the trust information available and/or accessible for the external domain (e.g., the DN, the AS/AF and/or the ASP etc.) to retrieve. The iTMF in the 3GPP system (e.g., the internal domain) may collect raw data (e.g., about a WTRU and/or the one or more users of the WTRU, and/or about 3GPP system etc.) and only expose and/or present high-level trust information to external entities such as the eTMF, which may protect user data privacy and/or 3GPP network data privacy. Upon obtaining the trust information of the WTRU from the 3GPP system, the external domain may have more complete information to perform an accurate trust evaluation for the WTRU and any running applications and/or functions on the WTRU. Here, the trust information may refer to any trust-related data, which may include a set of trust-related data (such as but not limited to user behavior data etc.), or a set of metrics such as but not limited to a value of a trust indicator and/or an overall trust index, etc.

Typically, to enable the wireless system to provide trust evaluation support to the external domain (e.g., the DN, the ASP, the WTRU, and/or another wireless network etc.), there are several key issues. In an issue, to expose the trust information to the external domain, the iTMF needs to acquire the consent from the WTRU and/or the one or more users of the WTRU. The WTRU may become unreachable when it is the time to expose the trust information. It may also cause a burden at the WTRU if the WTRU is contacted each time when the exposure of the trust information is requested. The WTRU and/or the one or more users of the WTRU may also wish control access to the trust information based on policy, preferences, and/or other reasons. It is a challenge to design an efficient and reliable approach that may enable trust information exposure and also guarantee the consent of the WTRU and/or the one or more users of the WTRU.

In an issue, the existing secondary authentication in conventional wireless systems in PDU session establishment does not consider the trust information of the WTRU initiating the PDU session establishment. If the trust information of the WTRU can be shared with the external DN-AAA server, the DN-AAA server could leverage the trust information to realize a stronger secondary authentication and in turn be able to assign one or more flexible and/or customized services to the WTRU. The issue is how to efficiently expose the trust information of the WTRU from the SMF to the DN-AAA server.

In an issue, the one or more applications in the external domain need to obtain trust-related support (e.g. trust evaluation and/or assessment) from the wireless system. Although vertical applications are different, their need for trust evaluation support from the wireless system is common. The issue is how to design this common need as an efficient service layer and/or service enabler layer and/or application enabler layer functionality, which may serve and be leveraged by different vertical applications without each application repeatedly implementing the same functionality of their own.

In an example, a function entity (FE) may include but is not limited to one or more processing functions, such as one or more NFs. This FE may also serve as the AF, an edge application or service, a device-provided service, a device-hosted application, and/or a server or a service within a data network, among other possibilities.

In an example, an FE service consumer (FESC) may include but is not limited to an FE that accesses one or more services provided by one or more FE service producers (e.g., an NF producer). The FE service consumer may be the NF consumer, a part of an NF, the AF, the edge application, a device-hosted application, and/or a server within a data network etc., for example. A device may be the FESC. A single device may have multiple FESCs.

In an example, an FE service producer (FESP) may include but is not limited to an FE that provides one or more services to one or more FE service consumers. The FE service producer may be the NF producer, a service provided by an NF, the AF, the edge application or service, the service enabler, and/or a service on another device. A device may be the FESP. A single device may have multiple FESPs.

In an example, a TMF may include an FE that may assess and/or calculate the trust index for other entities including but not limited to the device, the user, the AF, the NF, the service and/or the application etc. The TMF may assess and/or calculate one or more trust indexes of the FESCs and the FESPs. The TMF may also expose the calculated trust index (and/or other trust-related data) to other FEs within the same domain. When sharing the trust-related information with other TMFs across domains, the TMF requires permission from the subject entity (i.e., the FE) whose trust information is to be exposed.

In an example, a domain may include a self-governing operational environment with control over one or more internal resources, services, and/or policies etc. Examples of domains include but are not limited to a PLMN (e.g., a public network and/or a non-public network), a cloud service provider, an application service provider, an AI service provider, an internet service provider, and/or a social media platform etc. A cross-domain interaction may occur when two or more domains collaborate and/or exchange information, such as but not limited to PLMN-to-PLMN interactions or communications between a PLMN and an AF with a DN.

In an example, an iTMF and an eTMF may be described relative to the domain in which the WTRU is currently connected. The iTMF may operate within the current PLMN that the WTRU is currently connected, managing one or more trust evaluations and/or one or more service access decisions for that domain. The eTMF may reside outside the current PLMN and may belong to another domain such as but not limited to another PLMN, a cloud service provider, an application service provider, an AI service provider, an internet service provider, and/or a social media platform etc.

In an example, an identifier may include but is not limited to a name, an identity, and/or an address etc. of an entity (e.g., the user, the device, the FE, and/or an entity using a device, etc.). The identifier may be a 3GPP identifier, an internet protocol (IP) address, a uniform resource locator (URL), a fully qualified domain name (FQDN), a blockchain address, and/or a distributed user identifier, etc. In an example, the identifier of an entity may enable and/or provide one or more access details based on which other entities may access and/or interact with this entity.

In an example, a trust index (TIDX) may include a quantitative measure representing a trust level and/or trustworthiness of an entity (e.g., FE etc.) within a specified range and/or scale and/or related to a specific service. The TIDX may be generated by the TMF as the result of its trust evaluation. During this process, a confidence value may also be computed, which may reflect the certainty and/or reliability of the trust assessment. However, the confidence value may not be shared with one or more FEs. The one or more FEs may utilize the TIDX to determine their level of service accessibility and/or eligibility to interact with other FEs.

In an example, a trust indicator (TIDC) may include a set of trust metrics and/or key performance indicators (KPIs) that provide a multi-faceted assessment of trust. These indicators evaluate the performance of the FE from various perspectives, such as but not limited to throughput, latency, scalability, and/or other operational metrics etc. Unlike the TIDX, which provides an overall trust score based on a set of TIDC, the TIDC focuses on specific and measurable performance dimensions that contribute to the overall trust evaluation. The exact KPIs included in the TIDC may be service-dependent, meaning they may vary according to the specific requirements and/or characteristics of the service being accessed, requested and/or provided.

In an example, trust information (TINFO) may include a general term representing trust-related data associated with the FE. The TINFO may serve as an overarching concept that may refer to the TIDX, the TIDC, trust-related pre-processed data, and/or trust-related raw data etc., for example, depending on the specific service context.

In an example, a service ID (ServiceID) may include an identifier, a name, and/or a type of the target service and/or the specific service operation involved in the trust indicator and/or one or more trust index calculations, where the trust index may be calculated per service ID for the FESC and/or the FESP etc. Different service operations within the same service may be each assigned a unique service ID. These service operations may include but are not limited to service discovery, service initialization, service access, service information retrieval, service offloading, service adjustment, service subscription management, and/or service cancellation etc., for example.

In an example, a wireless network may include a wireless system such as but not limited to a PLMN, an NPN, a WiFi network, a customer premises network (CPN), a personal internet of things (IoT) network (PIN), a vehicular-to-everything (V2X) network, a connected robot network, and/or an aircraft-to-everything (A2X) network, etc. The wireless network serving the FE is referred to as a serving wireless network, which may be a visited wireless network and/or a home wireless network. The wireless network may be 5GS or 6GS or both. The wireless network may be a part of 5GS or 6GS or both. The wireless network and/or the wireless system may be interchangeably used.

In various embodiments, one or more design principles may be used to jointly leverage preconfigured exposure policies and/or instantaneous trust exposure approval and/or consent from the WTRU and/or the one or more users of the WTRU. Potential benefits of doing this include reducing overhead at the WTRU, maintaining controllability by the WTRU and/or the one or more users of the WTRU, and/or may be still workable when the WTRU is unreachable etc. As a design principle, if one or more information elements and/or parameters can be preconfigured or pre-provisioned, they do not need to be transmitted over an interface between the WTRU and the network. Potential benefits of doing this include reduced communication overhead, reduced information leakage and improved security, and/or reduced communication message processing overhead etc. A design principle may provide trust evaluation and/or exposure as a common functionality in the service layer and/or the service enabler layer and/or application enabler layer. Potential benefits of doing this include reduced application overhead, and/or to be leveraged by other functionalities in the application enabler layer etc.

In an embodiment, the 3GPP domain may expose the trust information to an application domain. In an example, the AS may require a trustworthiness assessment of the WTRU before providing one or more services to the WTRU. The wireless network domain such as the 3GPP domain may include the iTMF, which may collect and measure the trust information (e.g., one or more trust indicators and/or trust indexes etc.) about the WTRU and/or the one or more users and/or applications associated with the WTRU. The WTRU may create and/or configure one or more trust information exposure policies in the 3GPP domain. In an example, the AF and/or the NF may create similar trust information exposure policies for the WTRU. When the WTRU requests to access the one or more services and/or applications from the external domain such as the application domain, the external domain may not have sufficient information to evaluate the trust index of the WTRU. According to a set of trust information exposure policies, the iTMF may expose the trust information about the WTRU and the one or more users and/or applications to the eTMF in the external domain. Then, the eTMF may leverage the trust information obtained from the iTMF to evaluate the trust index of the WTRU. At last, the external domain may have sufficient information to authorize a request associated with the WTRU.

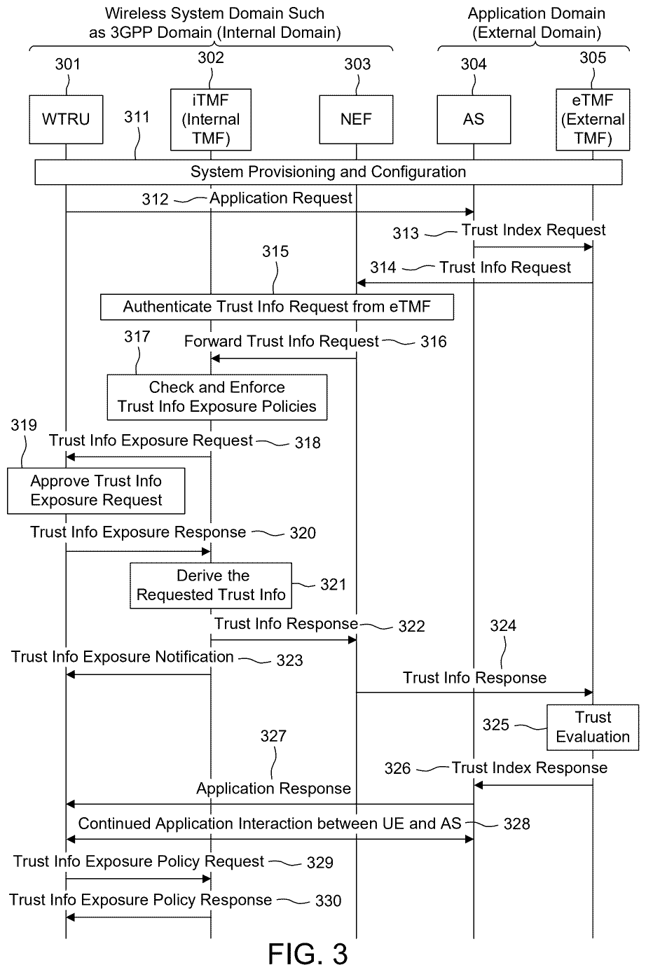

Referring now to FIG. 3, an example procedure of an AS providing the one or more services to a trustworthy WTRU is shown according to one or more embodiments. The procedure of FIG. 3 may be performed between a WTRU 301, an iTMF 302, an NEF 303, an AS 304, and/or an eTMF 305. The procedure illustrates the AS 304 providing one or more services to the WTRU 301, where the eTMF 305 in an external domain may actively retrieve extra and/or additional trust information of the WTRU 301 and one or more users and/or applications from the iTMF 302 in a 3GPP domain in order to more accurately evaluate a trust index of the WTRU 301 for the AS 304, especially when the eTMF 305 does not have adequate confidence in evaluating the trust index of the WTRU 301 by itself. One or more actors and/or logical NFs involved in the procedure include the WTRU 301, the iTMF 302, the NEF 303, the AS 304, the eTMF 305, and one or more other NFs (e.g., a PCF and/or an AMF etc.) not shown in FIG. 3. In an example, the AS 304 in FIG. 3 may be an AF too. The WTRU 301 may denote one or multiple users of the WTRU 301.

In an example, at 311, the WTRU 301 may be provisioned and/or configured with the address and/or the identifier of the iTMF 302. Otherwise, the WTRU 301 may discover the iTMF 302 from the other NFs in the 3GPP domain (e.g., the NRF, an AF/AS repository, and/or a service enabler function etc.). The WTRU 301 may also be provisioned with and/or discover the name, the address, and/or the identifier of the AS 304. The iTMF 302 may be provisioned with the name, address, and/or identifier of the eTMF 305 and one or more other eTMFs. The eTMF 305 may be provisioned with the address, the identifier, and/or an application programing interface (API) information of the NEF 303. The eTMF 305 may discover the NEF 303 from a repository function. The AS 304 and/or the eTMF 305 may be provisioned with the name of 3GPP domain and/or other domains that can provide extra trust information of the WTRU 301.

In an example, the WTRU 301 may report and/or indicate a trust capability in a form of a WTRU trust capability container (UETC-Container) to the iTMF 302 (and/or to the other NFs such as the PCF etc.). The UETC-Container may be piggybacked in a WTRU registration request, a service request, a PDU session establishment and/or modification request, and/or be included in a dedicated trust capability indication request sent from the WTRU 301 to the iTMF 302. If UETC-Container is piggybacked in the WTRU registration request, the service request, and/or the PDU session establishment and/or modification request, it may be first received by the AMF and/or the SMF, which may forward the UETC-Container to the iTMF 302. The UETC-Container may be a part of the subscription data of the WTRU 301 and/or the profile of the WTRU 301 stored in the 3GPP domain. Alternatively, the iTMF 302 and/or the other NFs may configure a default UETC-Container and/or send a new UETC-Container to the WTRU 301 (e.g., as a part of a WTRU registration accept, a WTRU context configuration, a PDU session establishment and/or modification response etc.). If the WTRU 301 does not have the UETC-Container, the WTRU 301 may also actively retrieve it from the iTMF 302 and/or the other NFs.

The UETC-Container may include a WTRU ID (e.g., a UE-ID) such as but not limited to the 3GPP identifier of the WTRU 301 (e.g., a subscription concealed identifier (SUCI) etc.). The UETC-Container may include a WTRU external ID (e.g., a UE-External-ID) which may refer to an external identifier of the WTRU 301. The UETC-Container may include willingness of trust information collection and/or measurement, which may be indicative of willingness of the WTRU 301 for the trust information to be collected, measured, and/or evaluated by the iTMF 302. In an example, one or more potential values of this parameter may be YES or NO. The UETC-Container may include willingness of trust information exposure, which may be indicative of willingness of the WTRU 301 for the trust information of the WTRU 301 to be exposed by the iTMF 302 to the other NFs and/or other domains. In an example, one or more potential values of this parameter may be YES or NO. The UETC-Container may include an eTMF-ID, which may be indicative of an identifier of one or multiple eTMFs that the WTRU 301 can interact with. The UETC-Container may include an iTMF-ID, which may be indicative of an identifier of one or multiple iTMFs that the WTRU 301 can interact with.

The UETC-Container may include one or more trust capabilities, including but not limited to a set of capabilities of the WTRU 301 in collecting, measuring, storing, processing, and/or reporting the trust information of the WTRU and/or other WTRUs, NFs, and/or applications. The capability may be described using the following parameters, such as but not limited to a capability level, a trust information evaluation formula, a trust information storage period, a trust information storage size, a trust information retrieval API, an object of trust capability, a time limitation of trust information capability, and/or a location limitation of the trust information capability etc.

In an example, the capability level may include one or more levels such as but not limited to trust information collection (to collect raw trust information), trust information evaluation (to process raw trust information to generate temporary and/or final trust index according to equations, methods, and/or functions as indicated by a trust information evaluation formula), a trust information storage (to store raw and/or processed trust information for a time period as indicated by trust information storage period), trust information retrieval (the raw and/or processed trust information that can and/or has to be retrieved via trust information retrieval API), and/or trust information reporting (to report raw and/or processed trust information to the iTMF 302) etc.

In an example, the trust information evaluation formula may include but is not limited to one or more equations, methods, and/or functions for the WTRU 301 to process collected raw trust information. The trust information storage period may include a time period (e.g., in minutes) indicating how long each piece of raw and/or processed trust information will be stored by the WTRU 301. The trust information storage size may include a storage size (e.g., in megabytes) that the WTRU 301 may use for storing raw and/or processed trust information. The trust information retrieval API may include an API information of the WTRU 301 that the other WTRUs, NFs, and/or applications may use to retrieve raw and/or the trust information from the WTRU 301. The object of trust capability may include an identifier of the WTRU 301 or other WTRUs, NFs, and/or applications, whose trust information may be collected, processed, stored, and/or reported by the WTRU 301. In an example, this parameter may refer to the applications on the WTRU 301 and the WTRU 301 may collect trust-related information of those applications. In the time limitation of trust information capability, the WTRU 301 may only have such trust information capability in one or a set of specific time periods. In the location limitation of trust information capability, the WTRU may only have such trust information capability when the WTRU 301 is in certain physical locations and/or regions etc. In the trust Information exposure approval capability, the capability of the WTRU 301 in verifying and/or approving the trust information exposure request that the iTMF 302 may send to the WTRU 301.

In an example, in the WTRU TINFO exposure policy creation and/or configuration, the WTRU 301 may create one or more WTRU TINFO exposure policies (UETINFO-EP) and send the one or more UETINFO-EPs to the iTMF 302 and/or the other NFs such as the PCF etc. Alternatively, one or more default UETINFO-EPs may be provisioned to the 3GPP domain (e.g., to the iTMF 302 and/or the other NFs such as the PCF etc.). In this case, if the WTRU 301 wants to know the UETINFO-EP, the WTRU 301 may retrieve the UETINFO-EP from the iTMF 302 and/or the other NFs, which may send the content of the UETINFO-EP of the WTRU 301 to the WTRU 301. The UETINFO-EP of the WTRU 301 is mainly used by the iTMF 302 and/or the other NFs to determine whether and/or how to exposure the trust information of the WTRU 301. The AF and/or the NF (e.g., the PCF etc.) may also create and/or send one or more WTRU TINFO exposure policies (UETINFO-EP) to the iTMF 302 and/or the 3GPP domain. The UETINFO-EP may include one or a set of WTRU TINFO exposure policies (EPs) for the WTRU 301.

In an example, a UETINFO-EP may include the WTRU ID (e.g., the UE-ID) which may be the 3GPP identifier of the WTRU 301 that UETINFO policy is about or applied to. The UETINFO-EP may include the WTRU external ID (UE-External-ID) which may include the external identifier of the WTRU 301 that that UETINFO policy is about or applied to.

In an example, each WTRU TINFO exposure policy may include a TINFO-EP-ID which may include an identifier of the TINFO exposure policy. The WTRU TINFO exposure policy may include a TINFO-EP-Precedence which may be indicative of a precedence of the TINFO exposure policy. The WTRU TINFO exposure policy may include one or more TINFO-EP-Conditions which may include one or more conditions (e.g., certain time periods and/or locations of the WTRU 301, the trust index of the WTRU 301 within a range or below a first threshold or above a second threshold etc.) under which this TINFO exposure policy can be applied.

In an example, the WTRU TINFO exposure policy may include but is not limited to TINFO-ID, which may include the identifier, the name, and/or the type of a specific piece of the trust information of the WTRU 301 that can be exposed based on this TINFO exposure policy. The WTRU TINFO exposure policy may include one or more Allowed-External-Requestors, which may include a list of external requestors (e.g., the eTMF) such as their identifiers, names, and/or addresses that the trust information of the WTRU 301 can be exposed to. This parameter may include the identifier, the name, and/or the type of eTMFs, the identifier, the name, and/or the type of external applications (e.g., the AFs and/or the ASs etc.), the identifier, the name, the type of external services, the identifier, the name, and/or the type of external domains etc.

In an example, the WTRU TINFO exposure policy may include one or more Prohibited-External-Requestors, which may include a list of external requestors (e.g., the eTMF) such as but not limited to their identifiers, the names, and/or the addresses that the trust information of the WTRU 301 cannot be exposed to. This parameter may include the identifier, the name, and/or the type of eTMFs, the identifier, the name, and/or type of external applications (e.g., the AFs and/or the ASs etc.), the identifier, the name, and/or the type of one or more external services, the identifier, the name, and/or the type of the one or more external domains.

In an example, the WTRU TINFO exposure policy may include one or more UE-Consent-Conditions, which may include one or more conditions for indicating whether the iTMF 302 needs to contact the WTRU 301 for an instantaneous or direct consent from the WTRU 301 for exposing the trust information to external requestors. The values of this parameter could be YES or NO without indicating any specific conditions. If “YES” and when this policy is applied, the iTMF 302 needs to contact the WTRU 301 for its consent when receiving the trust information request originated from the eTMF 305 on one or more Allowed-External-Requestors (i.e., to perform 318-320). In an example, each condition may be set for a specific eTMF and/or without indicating any eTMF, the conditions indicating specific eTMFs may have a higher priority than conditions without indicating any eTMF. This parameter may also indicate time and/or location conditions, for example, describing that the iTMF 302 only needs to contact the WTRU 301 for its consent during certain time periods or when the WTRU 301 is under certain physical locations and/or regions. Another example of UE-Consent-Conditions is a threshold trust index of the WTRU 301 and/or a range of trust indexes of the WTRU 301, which indicate that the iTMF 302 should (or should not) contact the WTRU 301 for its consent when the current trust index of the WTRU 301 as assessed by the iTMF 302 is above the threshold trust index, below the threshold trust index, and/or within a range of threshold trust indexes.

In an example, the WTRU TINFO exposure policy may include a UE-Notification, which may indicate whether a notification for each time of TINFO expose needs to be generated and sent to the WTRU 301. The values of this parameter may be YES or NO. The values of this parameter may be the threshold trust index of the WTRU 301 and/or the range of trust index of the WTRU 301, which indicates that the iTMF 302 should (or should not) notify the WTRU 301 when the current trust index of the WTRU 301 exposed by the iTMF 302 is above the threshold trust index, below the threshold trust index, and/or within the range of threshold trust indexes.

The NEF 303 may be configured with a TINFO request forwarding policy configuration. The iTMF 302 and/or the other NFs such as the PCF may configure one or more TINFO request forwarding policies (TINFO-RFP) to the NEF 303. When the NEF 303 receives a trust information request from the eTMF 304 and/or other entities in the external domains, the NEF 303 may find and/or may apply appropriate TINFO-RFP to determine if it accepts the trust information request and forwards it to the iTMF 302 or drop it. If the NEF 303 cannot find any appropriate and/or applicable TINFO-RFP for a received trust information request, the NEF 303 may contact the iTMF 302 and/or the PCF etc. to retrieve any new TINFO-RFP and apply the new TINFO-RFP to the received trust information request.

In an example, the TINFO-RFP may include one of multiple TINFO request forwarding policies. A TINFO request forwarding policy may include a TINFO-Exposure-Subject-ID, which may include an identifier of an exposure subject (e.g., the WTRU 301) whose trust information is requested to be exposed. The TINFO request forwarding policy may include a TINFO-Exposure-Requestor-ID, which may include the identifier, the name, and/or the type of the requestor of sending one or more trust information requests. For example, this parameter may contain the identifier of the eTMF. The TINFO request forwarding policy may include a TINFO-Exposure-App-ID, which may include the identifier, the name, and/or the type of the external application which will eventually use the exposed trust information. For example, this parameter may contain the identifier of the AS 304. The TINFO request forwarding policy may include the TINFO-Exposure-Service-ID, which may include the identifier, the name, and/or the type of the external service which may eventually use the exposed trust information. The TINFO request forwarding policy may include a TINFO-Exposure-External-Domain-ID, which may include the identifier, the name, and/or the type of the external domain which may eventually use the exposed trust information. The TINFO request forwarding policy may include one or more TINFO-RFP-Conditions, which may include one or more conditions (e.g., certain specific time periods) only under which a trust information request may be forwarded from the NEF 303 to the iTMF 302. If the trust information request is received by the NEF 303 beyond those specific time periods, the NEF 303 may not forward it to the iTMF 302. The TINFO request forwarding policy may include a TINFO-ID, which may include the identifier, the name, and/or the type of a specific piece of the trust information of the exposure subject that can be exposed. For example, if the trust information request aims to request other types of trust information (than described by this parameter), the NEF 303 may not forward this request to the iTMF 302.

Before 312 or any time between 312 and 327, the WTRU 301 may need to obtain the trust index of the AS 304. Then, the WTRU 301 may authenticate and/or authorize the AS 304 using an application-level signaling together with its trust index to determine if the AS 304 can be trusted. Until the AS 304 can be trusted, the WTRU 301 may issue an application request in 312.

At 312, the WTRU 301 may obtain the trust index of the AS 304 from the eTMF 305 that may provide and/or perform trust evaluation for the AS 304 (e.g., both the AS 304 and the eTMF 305 may be in the same external domain) by sending a trust index request including one or more parameters (such as but not limited to the identifier of the AS 304, the external identifier of the WTRU 301 (e.g., generic public subscription identifier (GPSI), the target services (e.g., ServiceID) that the WTRU 301 aims to access from the AS 304) to the eTMF 305. Then, the eTMF 305 may evaluate the trust index of the indicated AS 304 with regard to the target services for the WTRU 301 and send the evaluated trust index to the WTRU 301.

The WTRU 301 may not fully trust the eTMF 305 and may also request the trust index of the AS 304 from the iTMF 302 by sending a trust index request including parameters (such as but not limited to the identifier of the AS 304, the internal identifier of the WTRU 301, the target services (e.g., ServiceID) that the WTRU 301 aims to access from the AS 304) to the iTMF 302. Then, the iTMF 302 may evaluate the trust index of the indicated AS 304 with regard to one or more target services for the WTRU 301 and send the evaluated trust index to the WTRU 301. Since there may be many traffic flows between other WTRUs and the AS 304 and/or the AS 304 may have interacted with the internal domain (e.g., to request the internal domain to change and/or influence how the traffic flows between the AS 304 and the WTRUs should be treated and charged, etc.), the iTMF 302 may have such additional information about the AS 304 or be able to obtain such additional information about the AS 304 from internal domain. As such, the iTMF 302 can evaluate the trust index of the AS 304 too or provide such additional information in a different form to the WTRU 301.

Then WTRU 301 may determine if the AS 304 is trustable based on the trust information about the AS 304 from the eTMF 305, from the iTMF 302, and/or the other TMFs. If the AS 304 cannot be trusted (e.g., its trust index is below a threshold), the WTRU 301 may not send an application request to the AS 304 and/or may cancel any pending application request being sent to the AS 304.

At 312, the WTRU 301 may send the application request to the AS 304 for accessing the service, resource, and/or information provided by the AS 304. The AS 304 may be a function and/or a service on an application enabler layer, a service enabler layer, and/or a service layer etc. In this case, the request in 317 may be to access this function and/or service. This request may include an App-Request-ID indicative of an identifier of this application request. The request may include a UE-External-ID which may indicate an external identifier and/or an application-level identifier of the WTRU 301 that can be recognized by the AS 304. The request may include a UE-External-Credential, which may be indicative of a credential of the WTRU 301 to be used in the external domain. The request may include an internal-Domain-ID, which may be indicative of the identifier and/or the name of the internal domain (e.g., the 3GPP domain). The request may include an AS-ID which may be indicative of an identifier of the AS 304. The request may include an App-ID which may be indicative of the identifier, the name, and/or the type of the application that the WTRU 301 requests to access from the AS 304. The request may include a Service-ID, which may be indicative of the identifier, the name, and/or the type of the service, the resource, and/or the information that the WTRU 301 requests to access from the AS 304. The request may include an internal-TINFO-ID, which may be indicative of a list of identifiers, names, and/or types of trust information of the WTRU 301 that can be requested from or exposed by the iTMF 302. The request may include an iTMF-ID, which may be indicative of an identifier of the iTMF 302. The request may include other application-specific parameters.

At 313, the AS 304 receives the application request and may decide to use the trust information of the WTRU 301 to authenticate the application request. Then, the AS 304 may send a trust index request to the eTMF 305 for retrieving the trust index of the WTRU 301. This trust index request may include but is not limited to a UE-External-ID, an Internal-Domain-ID, an AS-ID, an App-ID, a Service-ID, an Internal-TINFO-ID, and/or an iTMF-ID etc. The Internal-Domain-ID may have been provisioned to the AS 304. Additionally or alternatively, the AS 304 can look up the Internal-Domain-ID for the WTRU 301 from its local database and/or from the external domain that the AS 304 resides.

At 314, the eTMF 305 may receive the trust index request and may determine that the eTMF 305 needs to retrieve additional trust information. The eTMF 305 may use the Internal-Domain-ID to find the identifier and/or address of the NEF 303. If the Internal-Domain-ID is not contained in 313, the eTMF 305 may use the UE-External-ID to first look up the Internal-Domain-ID and/or directly look up the identifier and/or the address of the NEF 303 from its local database and/or the external domain. Then, the eTMF 305 may generate a trust information request and may send it to the NEF 303. This trust information request may include a TINFO-Request-ID, which may be include the identifier and/or a sequence number of this request. The trust information request may include an eTMF-ID, which may include the identifier of the eTMF. The trust information request may include and eTMF-Credential, which may include a credential of the eTMF 305. The trust information request may include an AS-ID, as received at 313. The trust information request may include the External-Domain-ID, which may include the identifier of the external domain. The trust information request may include an App-ID, as received at 313. The trust information request may include a Service-ID, as received at 313. The trust information request may include a UE-External-ID, as received at 313. The trust information request may include a requested-TINFO-ID, which may include a list of one or more identifiers, names, and/or types of trust information of the WTRU 301 that the eTMF 305 requests to obtain from the iTMF 302. The Requested-TINFO-ID may be a subset or the full set of Internal-TINFO-ID as received at 313. If the Internal-TINFO-ID is not included at 313, it is assumed that the eTMF 305 may have been provisioned with the Internal-TINFO-ID and/or can discover the Internal-TINFO-ID from the iTMF 302 or other entities in the external domain. The Internal-Domain-ID, as received in 313 and/or derived by the eTMF 305. This trust information request may contain some application data (e.g., sensing data such as temperature reading from WTRU 201 in FIG. 2A), which the AS would request the iTMF to verify its trustworthiness; for this case, 322 and 324 may contain the trustworthiness of such application data. This trust information request may contain some application context data (e.g., location of the AS 304), based on which the NEF 303 may authenticate the trust information request 314 at 315 or based on which the iTMF 302 may determine whether to authenticate the trust information request 316 or not at 317.

At 315, the NEF 303 may receive the trust information request from the eTMF 305. The NEF 303 may first verify the eTMF-Credential. The NEF 303 may also authenticate the trust information request 314 based on application context data that may be contained in 314. The NEF 303 may record previous trust information requests from the same eTMF 305 and/or about the same AS 304; if trust information requests including 314 are too many within a time period (e.g., above a threshold) and/or if trust information requests including 314 are too frequent, the NEF may drop 314. Then, the NEF 303 may use the UE-External-ID to look up UE-ID (the 3GPP identifier of the WTRU 301) of the WTRU 301 from the other NFs (e.g., a unified data management (UDM) and/or a unified data repository (UDR) etc.). Then, the NEF 303 may use any configured TINFO request forwarding policies (TINFO-RFP) to determine if the trust information request may be forwarded to the iTMF 302 or rejected. If the TINFO-RFP allows multiple iTMFs that the NEF 303 can forward the trust information request to, the NEF 303 may select one iTMF in certain order (e.g., a random order, a round-robin, an iTMF that the NEF 303 successfully interacted more recently, an iTMF 302 that the NEF 303 has not contacted with for a long time, etc.). Alternatively or additionally, especially if the NEF 303 has no any TINFO-RFP, the NEF 303 may send a request to the iTMF 302 (or the other NFs such as the PCF etc.) to retrieve the latest TINFO-RFP and apply the latest TINFO-RFP to the received trust index request.

At 316, if the NEF 303 determines to forward the received trust information request, the NEF 303 may send the trust information request to the iTMF 302. The NEF 303 may remove the eTMF-ID, the eTMF-Credential, the AS-ID, the App-ID, and/or the Service-ID etc. from the trust information request. The NEF 303 may also insert the 3GPP identifier of the WTRU 301 (i.e., UE-ID) to the trust information request. The request may include the same TINFO-Request-ID as received at 314 or a transformed TINFO-Request-ID.

At 317, the iTMF 302 may receive the trust information request from the NEF 303. It may first extract the UE-ID from the request. Then, it looks up and applies the WTRU TINFO exposure policies (UETINFO-EP) to decide if the exposure of the request trust information of the WTRU 301 is allowed and/or if the iTMF 302 needs furthermore to contact the WTRU 301 for its consent before exposing its trust information. Note that the iTMF 302 may have stored some UETINFO-EP locally and/or the iTMF 302 may retrieve the latest UETINFO-EP from the other NFs such as the PCF etc. If the decision based on UETINFO-EP is to contact the WTRU 301 for its consent, 318-320 is needed, otherwise, 318-320 may be skipped. At 317, the iTMF 302 may derive the latest trust information of the WTRU 301 and uses it to compare against any applicable UETINFO-EP; for example, if the trust index of the WTRU 301 is below a threshold as described by a UETINFO-EP, the iTMF 302 may need to contact the WTRU 301 to obtain its consent.

At 318, the iTMF 302 may generate the trust information exposure request to the WTRU 301. This exposure request may include the eTMF-ID, the AS-ID, the App-ID, the Service-ID, the App-Request-ID, the UE-External-ID, the Requested-TINFO-ID, and/or the External-Domain-ID etc. Before 318, the iTMF 302 may derive the latest trust information of the WTRU 301 and contain it in the trust information exposure request at 318. The iTMF may also use 318 to request the WTRU 301 to report its latest context information via 320 to the iTMF 302.

At 319, the WTRU 301 may receive the trust information exposure request. The WTRU 301 may verify and approve (or reject) the request according to the parameters included in the request (e.g., the App-ID, the AS-ID, the App-Request-ID, the eTMF-ID, and/or the Requested-TINFO-ID etc.) and/or any locally stored UETINFO-EP etc.

At 320, the WTRU 301 may generate the trust information exposure response and send the trust information exposure response to the iTMF 302. The trust information exposure response may include but is not limited to a trust information exposure request status, such as APPROVED or REJECTED. In addition, the trust information exposure response may include and/or may piggyback new UETINFO-EP to be sent to the iTMF 302 for checking future trust information requests. For example, the WTRU 301 may use a new UETINFO-EP to information the iTMF 302 that there is no need for checking its consent, for example, during a future time period, before a designated deadline becomes due, for the next certain number of trust information request from the same eTMF, etc. The trust information exposure response may also contain the latest context information of the WTRU 301 (e.g., its location, its battery level, its available storage, its available computing power, etc.).

At 321, the iTMF 302 may receive the trust information exposure response from the WTRU 301. If this response includes new UETINFO-EP, the iTMF 302 may extract the new UETINFO-EP and store the new UETINFO-EP locally for future use. If the trust information exposure request status is APPROVED, the iTMF 302 may derive the requested trust information for the WTRU 301 as denoted by the Requested-TINFO-ID, which may be based on and/or leverage the latest context information of the WTRU 301 as contained in 320.

At 322, the iTMF 302 may generate a trust information response. This response may include the trust information as derived in 321 and/or may indicate REJECTED if the trust information exposure request status contained in 320 is REJECTED. This response may also include the signature of the iTMF 302. Based on the latest UETINFO-EP, the iTMF 302 may generate one or more trust index request hints (TINFO-Hint), for example, which types of trust information of the WTRU 301 may be requested at some specific time periods. The iTMF 302 may also provide TINFO-Hint in the trust information response. This response may also include the TINFO-Request-ID, which is the identifier of the trust information request sent in 316 or 314. This response may include the UE-ID.

At 323, the iTMF 302 may send a trust information exposure notification to the WTRU 301. This notification may contain a subset or the full set of parameters as included in trust information response sent in 322. This notification may contain the trust information of the WTRU 301 as derived in 321.

At 324, the NEF 303 may receive the trust information response from the iTMF 302. The NEF 303 may replace the UE-ID included in this response with the UE-External-ID. The NEF 303 may use the TINFO-Request-ID to identify the corresponding trust information request sent and find the right eTMF to receive this response. Then, the NEF 303 may forward the trust information response to the eTMF 305. The signature of the iTMF 302 may be included in this response.

At 325, the eTMF 305 may receive the trust information response from 324. If this response includes extra trust information of the WTRU 301 as derived in 321, the eTMF 305 may use such extra trust information of the WTRU 301 to derive the final trust index of the WTRU 301, otherwise, the eTMF 305 may still derive the final trust index of the WTRU 301 but only using local information that the eTMF 305 has.

At 326, the eTMF 305 may generate the trust index response and send the trust index response to the AS 304. The trust index response may include the final trust index of the WTRU 301 and the UE-External-ID.

At 327, the AS may receive the trust index response from the eTMF 305. The AS 304 may leverage the final trust index of the WTRU 301 to authenticate the application request received from 312; the authentication result could be APPROVED, REJECTED due to low trust index, or REJETED due to other reasons etc. If the authentication result is APPROVED, the AS 304 may perform an application logic and/or one or more tasks as requested by the application request and may generate an application result. Then, the AS 304 may generate the application response and send the application response to the WTRU 301. This response may include the authentication result and/or the application result.

At 328, the WTRU 301 may receive the application response. The WTRU 301 may continue to send more application requests to the AS 304.

At 329 and/or at any time after 327 or 328, the WTRU 301 may want to update the one or more WTRU TINFO exposure policies (UETINFO-EP) stored at the iTMF 302 and/or the other NFs (e.g., the PCF etc.), including creating new policies and modifying and/or deleting existing policies. For this purpose, the WTRU 301 may generate the trust information exposure policy request and send the trust information exposure policy request to the iTMF 302 and/or the other NFs such as the PCF. The trust information exposure policy request may include the UE-ID, such as the 3GPP identifier of the WTRU 301 (e.g., the SUCI). The request may include a Request-Type indicative of the request type such as but not limited to: create new UETINFO-EP, modify existing UETINFO-EP, and/or delete existing UETINFO-EP etc. The request may include the UETINFO-EP-ID including an identifier of an existing WTRU TINFO exposure policy to be modified and/or deleted. The request may include UETINFO-EP-Content including the content of a new WTRU TINFO exposure policy to be created and/or the content of an existing WTRU TINFO exposure policy to be modified.

At 330, the iTMF 302 may receive the trust information exposure policy request and perform the corresponding actions as indicated by Request-Type. If the iTMF 302 creates new UETINFO-EP and/or modifies existing UETINFO-EP as requested, the iTMF 302 may store new and/or modified UETINFO-EP to the other NFs such as the PCF. If the iTMF 302 deletes existing UETINFO-EP, the iTMF 302 may delete the same UETINFO-EP from the other NFs such as the PCF. The iTMF 302 may also analyze the changes to the UETINFO-EP (created new ones, modified existing ones, or deleted existing ones) and determine any needed changes to a TINFO request forwarding policy (TINFO-RFP). The iTMF 302 may enforce the changes to the TINFO-RFP by sending them to the NEF 303.

In one or more embodiments, the WTRU may needs to discover other trustworthy WTRUs via the AS. In an example, two (or even more) WTRUs, e.g., a first WTRU (WTRU-1) and a second WTRU (WTRU-2), interact with each other at the application level with the assistance of the AS. For example, the WTRU-1 aims to use computing and AI service provided by the WTRU-2. Specifically, both the WTRU-1 and the WTRU-2 first register to the AS. Then, the WTRU-1 may discover other target WTRUs. The target WTRUs may not only provide expected services that the WTRU-1 requests and also should have a trust index above a threshold. The AS may first select some WTRU candidates. Then, the AS may leverage an eTMF to evaluate the trust index of those WTRU candidates. For a more complete and accurate trust evaluation of the WTRU candidates, the eTMF may request extra trust information of the WTRU candidates from the iTMF in the 3GPP domain and leverage extra trust information to derive the final trust index of each WTRU candidate The AS may determine the final discoveree from the WTRU candidates based on their final trust index; for example, the WTRU candidates with the highest final trust index and/or with their final trust index above the threshold may be determined as the final discoveree.

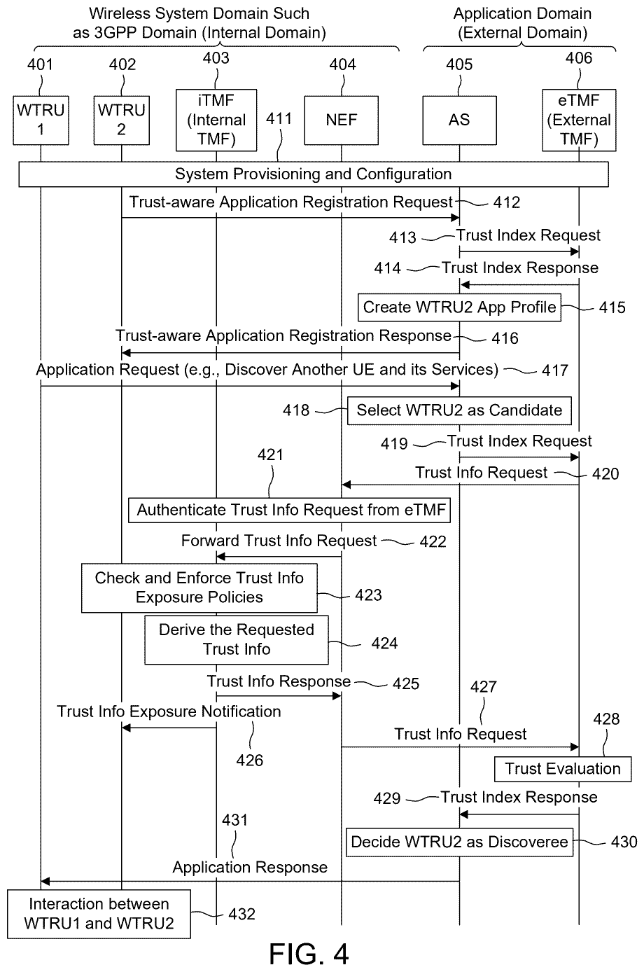

Referring now to FIG. 4, an example procedure illustrating a WTRU discovering other trustworthy WTRUs from an AS according to one or more embodiments. One or more entities, actors and/or logical NFs involved in this procedure include a first WTRU (WTRU-1) 401 (e.g., a discoverer), a second WTRU (WTRU-2) 402 (e.g., a discoveree), an iTMF 403, an NEF 404, an AS 405, an eTMF 406, and the other NFs (e.g., the PCF and/or the AMF etc.) not shown in the figure. In an example, the AS 405 in FIG. 4 may be an AF too. The WTRU-1 401 may be one or multiple users of the WTRU-401.

At 411, system provisioning and/or configuration may be performed for both the WTRU-1 401 and the WTRU-2 402. In an example, 411 may be similar to 313 of FIG. 3.

412, 413, 414, 415, and 416 may be used for registering the WTRU-2 402 to the AS 405. It is assumed that the WTRU-1 401 uses 412-416 to register itself to the AS 405. The WTRU-2 402 may generate a trust-aware application registration request and may send it to the AS 405. The trust-aware application registration request may include a Requestor-ID indicative of an application-level identifier of the WTRU-2 402 (e.g., the UE-External-ID of the WTRU-2 402). The trust-aware application registration request may include a Local-Service-ID, which may include a list of the identifiers, the names, and/or the types of local services that the WTRU-2 402 can provide to the other WTRUs. The trust-aware application registration request may include an app-level trust capability indicative of trust capability of the WTRU-2 402 at the application level, which may include the willingness of the WTRU-2 402 that its trust index can be evaluated by the AS 405. The app-level trust capability may include the willingness of the WTRU-2 402 that its trust index can be leveraged by the AS 405 to determine if it can be discovered by the other WTRUs as a trustworthy WTRU. The app-level trust capability may include the willingness of the WTRU-2 402 that its trust index can be leveraged by the AS 405 to determine if it can request services from the AS 305. The app-level trust capability may include an Internal-Domain-ID including a list of the identifiers and/or names of any internal domains which can provide extra and/or additional trust information of the WTRU-2 402 to the AS 405 or other external domains. The app-level trust capability may include the iTMF-ID, may include a list of the identifiers and/or the names of iTMFs that can provide or expose extra trust information of the WTRU-2 402 to the AS 405 and/or other external domains. The app-level trust capability may include an indication that the WTRU-2 402 needs the AS 405 to discover other trustworthy WTRUs based on their trust index for the WTRU-2 402. If the WTRU-1 401 registers itself to the AS 405, the WTRU-1 401 may indicate to the AS 405 if the WTRU-1 401 needs the AS 405 to discover the other trustworthy WTRUs based on their trust index for the WTRU-1 401. The app-level trust capability may include an indication that WTRU-2 402 needs to use one or more trust indexes of the other WTRUs to determine if they can access services of the WTRU-2 402.

At 412, the AS 405 receives the trust-aware application registration request. For authenticating this request, the AS 405 needs to know the trust index of the WTRU-2 402. The AS 405 may generate a trust index request and may send it to the eTMF 406. In an example, the trust index request may be similar to 313 of FIG. 3. For example, the trust index request may include the UE-External-ID of the WTRU-2 402. The purpose of the trust index may be for authenticating the application request. Additionally or optionally, a subset or the full set of parameters of the trust-aware application registration request.

At 414, the eTMF 406 derives the trust index of the WTRU-2 402. For the purpose of authenticating application registration request, the eTMF 406 may not need to retrieve any extra trust information of the WTRU-2 402. As such, the eTMF 406 may generate a trust index of the WTRU-2 402 and may generate a trust index response containing the trust index of the WTRU-2 402. The eTMF 406 may send the trust index response to the AS 405. This may be similar to 314 of FIG. 3.

At 415, the AS 405 may receive the trust index response from the eTMF 406. In an example, the trust index of the WTRU-2 402 may be above the threshold. In that case, the AS 405 may approve the application registration request received from 412; otherwise, the AS 405 may reject the application registration request and send a rejection notification to the WTRU-2 402 in 416 and other tasks may be skipped. Then, the AS 405 may create an application and/or service profile for the WTRU-2 402, which may include a UE-App-Profile-ID, which may include the identifier of the created application and/or service profile for the WTRU-2 402. The application and/or service profile my include a UE-External-ID of the WTRU-2 402. The application and/or service profile may include a Local-Service-ID as received in 412. The application and/or service profile may include an app-level trust capability as received at 412.

At 416, the AS 405 may generate a trust-aware application registration response and may send the trust-aware application registration response to the WTRU-2 402. The trust-aware application registration response may include UE-App-Profile-ID and the identifier of eTMF (eTMF-ID). 412-416 may be used for the WTRU-2 402 to perform a trust-aware application registration with the AS 405. It may have no correlation with 417-432. If 412-416 take place after 417, the WTRU-2 402 may not be selected by the AS 405. But 412-416 may happen any time before 417.

At 417, the WTRU-1 401 needs to find nearby and trustworthy WTRUs, which may provide expected services (e.g., computing and AI services) directly to the WTRU-1 401. The WTRU-1 401 may send the application request (e.g., a WTRU and service discovery request) to the AS 405. The AS 405 may be a function and/or a service on the application enabler layer, the service enabler layer, and/or the service layer. In this case, the request in 417 may be to access this function and/or service. This application request may include the Trust-Index-Threshold indicative of the trust index threshold for discovering the other WTRUs. In other words, the other WTRUs only if their trust index is above the threshold trust index may be regarded as trustworthy from perspective of the WTRU-1 401. The AS 405 may determine those WTRUs as discoveree and returns them to the WTRU-1 401. The application request may include one or more Expected-Service-IDs includes a list of expected services that the other WTRUs can provide. For each different service, the WTRU-1 401 may provide the same or a different Trust-Index-Threshold. The application request may include other trust requirements on other WTRUs to be discovered. For example, the WTRU-1 401 may need other WTRUs to use trust index to determine service access.

At 418, the AS 405 may receive the trust the application request. The AS 405 may first perform 313-326 of FIG. 3 to obtain the trust index of the WTRU-1 401. The AS 405 may use the trust index of the WTRU-1 401 to authenticate the application request from 417 and determine if the WTRU-1 401 is allowed to discover the other WTRUs. In an example, assuming that the WTRU-1 401 is allowed, the AS 405 may continue to perform the following operations; otherwise, the AS 405 may send a rejection notification in 431 to the WTRU-1 401 and skip 419-430. It may look up locally stored app and/or service profile of the other WTRUs to select a list of initial WTRU candidates which can provide services as indicated by Expected-Service-IDs. In an example, assuming the WTRU-2 402 is on the list of initial WTRU candidates. Before determining the final discoveree, the AS 405 needs to know the trust index of each WTRU candidate using 419-429.

At 419-429, one or more processes may be performed for each of initial WTRU candidates. Alternatively, 419-429 may be executed just once to obtain the trust index of all initial WTRU candidates.

At 419, similar to 313 of FIG. 3, a UE-External-ID of the WTRU-2 402 (and/or each of other initial WTRU candidates) may be included in the trust index request in 419.

At 420, similar to 314 of FIG. 3, the UE-External-ID of the WTRU-2 402 (and/or each of other initial WTRU candidates) may be included in this trust information request in 419.

At 421, similar to 315 of FIG. 3, the NEF 404 may need to find and determine a 3GPP identifier of the WTRU-2 402 (and/or each of other initial WTRU candidates etc.).

The procedure at 422 may be similar to 316 of FIG. 3.

At 423, similar to 317 of FIG. 3, the iTMF 403 may apply the UETINFO-EP of the WTRU-2 402 (and/or each of other initial WTRU candidates).

If UETINFO-EP of the WTRU-2 402 (and/or each of other initial WTRU candidates) requests the iTMF 403 to obtain their consent, the iTMF 403 may perform one or more processes similar to 318-320 of FIG. 3 for the WTRU-2 402 (and/or each of other initial WTRU candidates).

At 424, similar to 321 of FIG. 3, the iTMF 403 may derive the requested trust information of the WTRU-2 402 (and/or each of other initial WTRU candidates).

At 425, similar to 322 of FIG. 3, the trust information response may include extra and/or additional trust information of the WTRU-2 402 (and/or each of other initial WTRU candidates) and the signature of the iTMF 405.

At 426, similar to 323 of FIG. 3, the iTMF 403 may send a trust information exposure notification to the WTRU-2 402 (and/or each of other initial WTRU candidates).

The procedure at 427 may be similar to 324 of FIG. 3.

At 428, similar to 325 of FIG. 3. The eTMF 406 may derive the final trust index of the WTRU-2 402 (and/or each of other initial WTRU candidates) using the trust information response received at 427.

At 429, similar to 326 of FIG. 3, the trust index response may include the final trust index of the WTRU-2 402 (and/or each of other initial WTRU candidates).

At 430, the AS 405 may receive the final trust index of all initial WTRU candidates including the WTRU-2 402. The WTRU candidates with their final trust index above the Trust-Index-Threshold may be selected as the final discoveree. In an example, the WTRU-2 402 may be one of the final discoveree.

At 431, similar to 327 of FIG. 3, the application response may also include a list of the final discoverees determined in 430.

At 432, the WTRU-1 401 may receive the application response. It can start to interact with the WTRU-2 402 and/or other final discoverees.

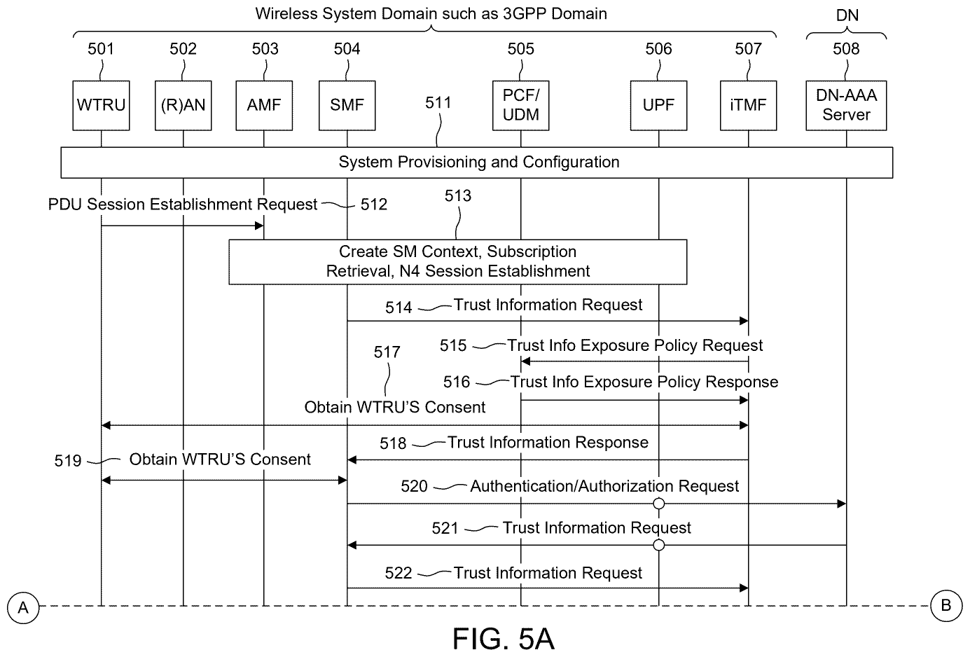

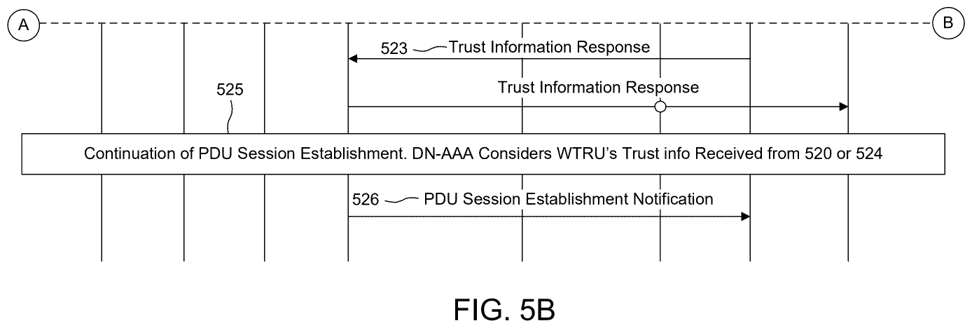

Referring now to FIGS. 5A-5B, an example procedure of a trust-aware PDU session establishment is shown according to one or more embodiments. The procedure may be performed using a WTRU 501, a RAN 502, an AMF 503, an SMF 504, a PCF/UDM 505, a UPF 506, an iTMF 507, and a DN-AAA server 508.

The trust information may also be leveraged in PDU session establishment to enhance secondary authentication in the 5GS. The 3GPP system performs secondary authentication for verifying an access rights of a WTRU to the one or more external services and/or applications (e.g., those from service or content providers). Current methods primarily involve the SMF forwarding WTRU-provided credentials (e.g., usernames and/or passwords, etc.) to a DN-AAA server in an external DN and/or an external provider domain. Existing secondary authentication itself is essentially a credential-based approach. However, telecom operators can enhance this process beyond simple credential forwarding with trust-aware authentication assistance by providing trust information of a WTRU to a DN-AAA server. Trust-aware authentication can the a DN-AAA server with a better awareness of the trust index of a WTRU, based on which the DN-AAA server can provide flexible and/or customized services to the WTRU.

In FIGS. 5A-5B, the iTMF 507 can be implemented as a part of the PCF and/or the NWDAF etc.

The procedure at 511 may be similar to 311 of FIG. 3.

At 512, the WTRU 501 may send a PDU session establishment request to the AMF 503. The PDU session establishment request may include a trust information exposure indication (TINFO-EI), which indicates the WTRU 501 is willing for exposing its trust information to the DN-AAA server 508. If the WTRU 501 already has its trust information, this request may piggyback its trust information with the signature of the entity that generated the trust information. The value of TINFO-EI may be YES or NO.

At 513, one or more existing operations (e.g., creating SM context, retrieving subscription data from UDM, establishing N4 session), as a part of PDU session establishment, may be performed.

At 514, the SMF 504 may generate a trust information request and send the trust information request to the iTMF 507, especially if TINFO-EI=YES is included in the PDU session establishment request. The SMF 504 may also first retrieve one or more policies from the PCF or the WTRU subscription data from the UDM to check if it is allowed and/or supposed to expose the trust information of the WTRU 501 to the DN-AAA server 508 for secondary authentication. If the SMF 504 does not have an iTMF, the SMF 504 may contact the other NFs (e.g., the NRF, the PCF, the UDM, and/or UDR etc.) and provide the WTRU identifier to find an iTMF that can provide trust information of the WTRU 501. If TINFO-EI=NO or WTRU subscription data and/or policies do not allow trust information exposure, 514-517 and 519-522 may be skipped. This request may indicate that the SMF 504 needs to know all trust information of the WTRU 501, and/or the SMF 504 only needs to know the identifiers, the names, and/or the types of trust information (UE-TINFO-ID) that the iTMF 507 can provide about the WTRU 501; and/or the SMF 504 wants to retrieve a specific type of trust information of the WTRU 501 from the iTMF 507 by additionally indicating the UE-TINFO-ID. This request may also include the identifier, the name, and/or the address of the DN-AAA server 508.

At 515, the iTMF 507 may receive the trust information request from the SMF 504. Before sending the trust information of the WTRU 501 to the SMF 504, the iTMF 507 may send a trust information exposure policy request to the PCF 505 to retrieve any applicable exposure policies related to the WTRU 501, the SMF 504 and the DN-AAA server 508. This request may contain the identifier of WTRU 501, the identifier of the SMF 504, the identifier of the DN-AAA server 508.

At 516, the PCF 505 may receive the trust information exposure policy request. The PCF 505 uses the identifier of the WTRU 501, the identifier of the SMF 504, the identifier of the DN-AAA server 508, and/or other information (e.g., WTRU context information and/or WTRU subscription data etc.) to discover any applicable trust information exposure policies. The PCF 505 may generate a trust information exposure policy response and sends the trust information exposure policy response to the iTMF 507. This response may include the discovered trust information exposure policies and the identifier of the WTRU 501. If the iTMF 507 has applicable trust information exposure policies locally, the iTMF 507 may use them directly and 515-516 may be skipped.

At 517, the iTMF 507 may use the one or more trust information exposure policies locally found and/or received from the PCF 505 to determine whether and how the trust index of the WTRU 501 can be sent to the SMF 504. The iTMF 507 may also contact the WTRU 501 giving the identifier of the DN-AAA server 508 to the WTRU 501 to obtain its consent, similar to 318-320 in FIG. 3.

At 518, in an example, the local exposure policies may allow or the iTMF 507 may obtain consent of the WTRU 501 via 517, the iTMF 507 may generate a trust information response and may send the trust information response to the SMF 504. The trust information response may include “REJECTED DUE TO EXPOSURE POLICIES” if the trust information exposure policies do not allow the iTMF 507 to expose the trust information of the WTRU 501.

If 514 only requested the identifiers, the types, and/or the names of the trust information of the WTRU 501 and the trust information exposure policies allow to do it, this response may include UE-TINFO-ID. If 514 requested the trust information of the WTRU 501 and the trust information exposure policies allow to do it, this response may include the trust information of the WTRU 501 and the signature of the iTMF 507. In this case, 522-523 may be skipped. If 514 requested the trust information for a particular UE-TINFO-ID, this response may only include the piece of trust information of the WTRU 501 corresponding to UE-TINFO-ID indicated in 514. This response may also contain the signature of the iTMF 507. If 517 has been performed, this response may also indicate that the consent of the WTRU 501 has been obtained or this response included the consent. In this case, 519 may be skipped.

At 519, the SMF 504 may contact the WTRU 501 to obtain its consent for exposing its trust information or UE-TINFO-ID to the DN-AAA server 508, similar to 517. When the SMF 504 contacts the WTRU 501, the SMF 504 may include the identifier of the DN-AAA server 508. If 517 took place, 519 may not be needed.

At 520, the SMF 504 may send an authentication and/or authorization request to the DN-AAA server 508. This request may additionally include the trust information of the WTRU 501 or UE-TINFO-ID as received from 519. If this request only includes UE-TINFO-ID, the DN-AAA server 508 may need to use 521-524 to retrieve the trust information of the WTRU 501 from the SMF 504; otherwise, 521-524 may be skipped.

At 521, if 520 does not include the trust information of the WTRU 501 but UE-TINFO-ID, the DN-AAA server 508 may select some identifiers, names, and/or types of the trust information of the WTRU 501 from the set of UE-TINFO-ID (referred to as selected UE-TINFO-ID). Then the DN-AAA server 508 may send a trust information request to the SMF 504 to retrieve selected trust information. This request may include selected UE-TINFO-ID and the identifier of the DN-AAA server 508.

The SMF 504 may receive the trust information request from the DN-AAA server 508. If the SMF 504 already received the trust information of the WTRU 501 (e.g., from 518), the SMF 504 can use it to match the selected UE-TINFO-ID and send corresponding trust information of the WTRU 501 in 524 to the DN-AAA server 508; in this case, 522-523 may be skipped. If the SMF does not have any trust information of the WTRU 501 matching the selected UE-TINFO-ID, the SMF 504 may use 522-523 to retrieve needed trust information to of the WTRU 501 from the iTMF 507.

At 522, the SMF 504 may send a trust information request to the iTMF 507, similar to 514. This request may contain the selected UE-TINFO-ID. This request may also contain the identifier of the DN-AAA server 508.

At 523, the iTMF 507 may receive the trust information request. The iTMF 507 may use any applicable trust information exposure policies locally found or received from 516 to determine if the trust information of the WTRU 501 can be exposed to the DN-AAA server 508. The iTMF 507 may also contact the WTRU 501 giving the identifier of the DN-AAA server 508 to the WTRU 501 to obtain its consent, similar to 517. Then, the iTMF 507 may generate a trust information response and sends the trust information response to the SMF 504. The trust information response may include some trust information of the WTRU 501 corresponding to the selected UE-TINFO-ID.

At 524, the SMF 504 may generate a trust information response containing the trust information received from 523 or selected from locally cached trust information of the WTRU 501. This response may also contain the external identifier of the WTRU 501 (e.g., GPSI). The SMF 504 may send this response to the DN-AAA server 508.

At 525, the rest of PDU session establishment operations are continued. For example, the DN-AAA server 508 may leverage the trust information of the WTRU 501 received from 520 and/or 524 to perform trust-aware authentication and authorization of the WTRU 501. If the receive trust information is not a trust index, the DN-AAA server 508 may first transform it to a trust index. Then, in an example, only if the trust index of the WTRU 501 is above a threshold and/or within a specific range, the DN-AAA server 508 accepts or approves the WTRU 501 and assigns selected services reflecting the trust index of the WTRU 501 to the WTRU 501. If the WTRU 501 has a higher trust index, the DN-AAA server 508 may assign more or better services to the WTRU 501.

As a part of 525, when the WTRU 501 presents it credentials to the DN-AAA server 508, the WTRU 501 may present its trust index to the DN-AAA server 508 at the same time. In this case, 514-518 and 521-524 may be skipped.

If 514-518 and 521-524 were not executed, 514-518 and 521-524 can be executed as a part of 525 before the DN-AAA server 508 confirms the successful authentication and/or authorization of the PDU session.

At 526, after the PDU session is successfully established, the SMF 504 may send a PDU session establishment notification to the iTMF 507. This notification may include any context information about the established PDU session (e.g., PDU session ID, the identifier of the WTRU 501, the identifier of the DN-AAA server 508, the approved QoS parameters and/or characteristics of the QoS flow associated with the PDU session, etc.). The iTMF 507 may use such PDU session context information to update the trust information of the WTRU 501.

In one or more embodiments, the trust evaluation and exposure may be performed in the application enabler layer. In a trustworthy application enabler architecture, the trust evaluation can be realized in the application enabler layer (and/or the service enabler layer and/or the service layer etc.) to empower a trustworthy application enabler layer, where there is a trust enabler client (TEC) on the WTRU and a trust enabler server (TES) in a DN domain.

The TEC may provide one or more trust-related services and/or functionalities to one or more application enabler clients (AEC) on the WTRU such as but not limited to an edge enabler client (EEC), a future of factories application enabler client (FAE client), a V2X application enabler client (VAE client). In an example, one or more vertical application layer clients (VAL clients) can leverage one or more trust-related services and/or functionalities of the TEC via corresponding AEC and/or directly interacting with the TEC etc. The one or more trust-related services and functionalities provided by the TEC may include but are not limited to receiving trust evaluation instructions from the TES. The one or more trust-related services and functionalities provided by the TEC may include collecting raw trust information about AECs and their supported VAL clients, based on local evaluation instructions and/or trust evaluation instructions from the TES. The one or more trust-related services and functionalities provided by the TEC may include evaluating the trust index of AECs and their supported VAL clients, based on local evaluation instructions and/or trust evaluation instructions from the TES. The one or more trust-related services and functionalities provided by the TEC may include supporting the AECs and their supported VAL clients to look up their trust index. The one or more trust-related services and functionalities provided by the TEC may include providing raw trust information and evaluated trust index of the AECs and their supported VAL clients to the TES and corresponding AESs. The one or more trust-related services and functionalities provided by the TEC may include evaluating the trust index of the WTRU based on the behaviors and the trust index of all the AECs and all the VAL clients on the WTRU, based on local evaluation instructions and/or trust evaluation instructions from the TES. The one or more trust-related services and functionalities provided by the TEC may include providing the evaluated trust index of the WTRU to the TES. The one or more trust-related services and functionalities provided by the TEC may include providing trust information exposure policies to an iTMF in a wireless network (e.g., 5GS or 6GS). The one or more trust-related services and functionalities provided by the TEC may include approving trust information exposure request from an iTMF on behalf of the WTRU and/or the users on the WTRU. The one or more trust-related services and functionalities provided by the TEC may include providing trust information exposure assistance to the TES. The one or more trust-related services and functionalities provided by the TEC may include request the trust index of an AES (e.g., EES) from the TES and provide it to the corresponding AEC (e.g., EEC) and the one or more VAL client (e.g., AC).

The TES may provide the one or more trust-related services and/or functionalities to the TEC and other AESs in the DN domain. The AESs may include but are not limited to edge enabler server (EES), FAE server, and/or VAE server etc. The VAL servers also can leverage the one or more trust-related services and functionalities of the TES via their corresponding AES and/or directly interacting with the TES. The one or more trust-related services and functionalities provided by the TES may include but not limited to providing trust evaluation instructions to the TEC. The one or more trust-related services and functionalities provided by the TES may include requesting trust information exposure assistance from the TEC. The one or more trust-related services and functionalities provided by the TES may include requesting trust information exposure from an iTMF in a wireless network (e.g., the 5GS and/or the 6GS etc.). The one or more trust-related services and functionalities provided by the TES may include evaluating the trust index of AECs and their supported VAL clients based on the information or feedback received from the TEC. The one or more trust-related services and functionalities provided by the TES may include evaluating the trust index of AESs and their supported VAL servers. The one or more trust-related services and functionalities provided by the TES may include supporting the one or more AECs and their supported VAL clients to look up their trust index. The one or more trust-related services and functionalities provided by the TES may include supporting the one or more AESs and their supported VAS clients to look up their trust index. The one or more trust-related services and functionalities provided by the TES may include supporting the AES to look up the trust index of the AECs that the AES manages and/or that are registered with the AES. The one or more trust-related services and functionalities provided by the TES may include requesting addition trust index about the TEC, an AEC, and/or a WTRU from an iTMF in the 5GS and/or the 6GS. The one or more trust-related services and functionalities provided by the TES may include requesting the trust exposure assistance from the TEC.

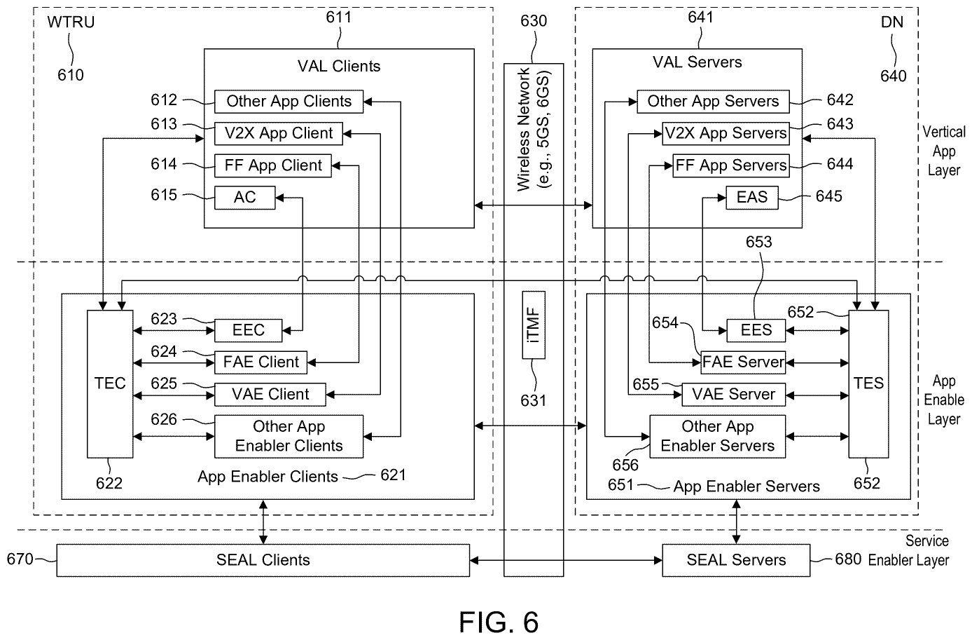

Referring now to FIG. 6, a trustworthy application enabler architecture is shown according to one or more embodiments. The trustworthy application enabler architecture includes a WTRU 610, a wireless network 630, and a DN 640. The WTRU 610 includes one or more VAL clients 611 including other application clients 612, a V2X application client 613, an FF application client 614, and an AC 615. The WTRU 610 includes one or more application enabler clients 621 including a TEC 622, an EEC 623, an FAE client 624, a VAE client 625, and one or more application enabler clients 626. The wireless network 630 may include an iTMF 631. The DN 640 includes one or more VAL servers 641 including other application servers 642, a V2X application server 643, an FF application server 644, and an EAS 645. The DN 640 includes one or more application enabler servers 651 including a TES 652, an EES 653, an FAE server 654, a VAE server 655, and one or more application enabler servers 656. The trustworthy application enabler architecture includes SEAL clients 670 and SEAL servers 680.

The TES 652 may request trust information of the WTRU 610 from the iTMF 631. When the VAL client 611 on the WTRU 610 sends an application request to a VAL server 641 for application layer interaction, the VAL server 641 may need to obtain the trust index of the VAL client 611 in order to authenticate the application request from the VAL client 611, referred to as “authentication based on trust index”. The VAL server 641 can request such trust index directly from the TES 652 or indirectly via the AES.

In either case, the TES 652 may not have sufficient information to evaluate the trust index of the VAL client 611; for example, the trust index of the VAL client 611 may depend on the trust index of the WTRU 610, which the TES 652 may not have. Then, the TES 652 may request extra trust information of the WTRU 610 from the iTMF 631 in the 3GPP domain (e.g., the wireless network 630), based on which the TES 652 evaluates the trust index of the VAL client 611. The TES 652 presents the trust index of the VAL client 611 and/or the WTRU 610 to the VAL server 641. Finally, the VAL server 641 authenticates the VAL client 611 using its trust index and optionally the trust index of the WTRU 610. If the authentication passes, the VAL server 641 starts to serve the application request.

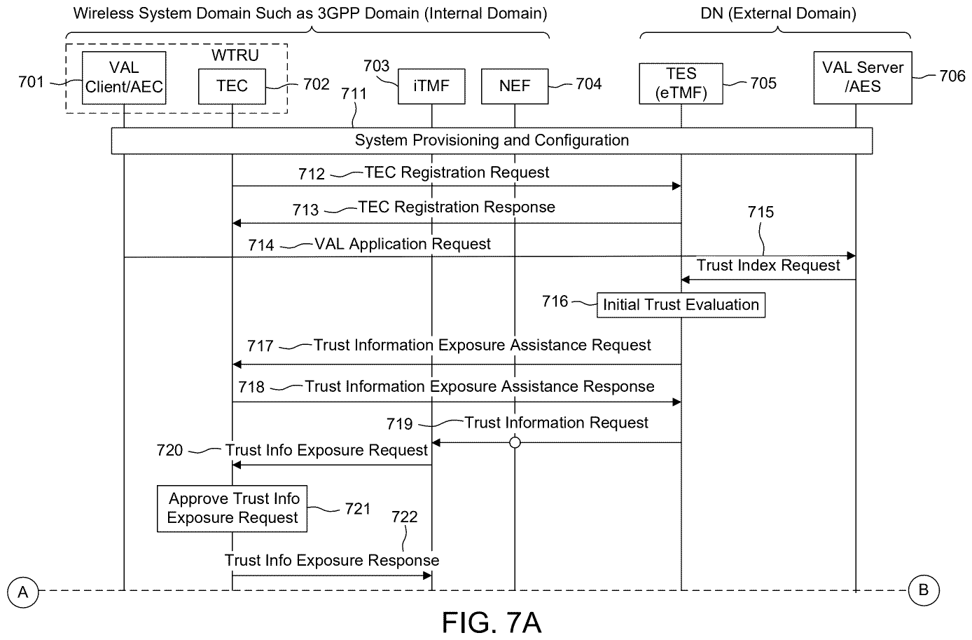

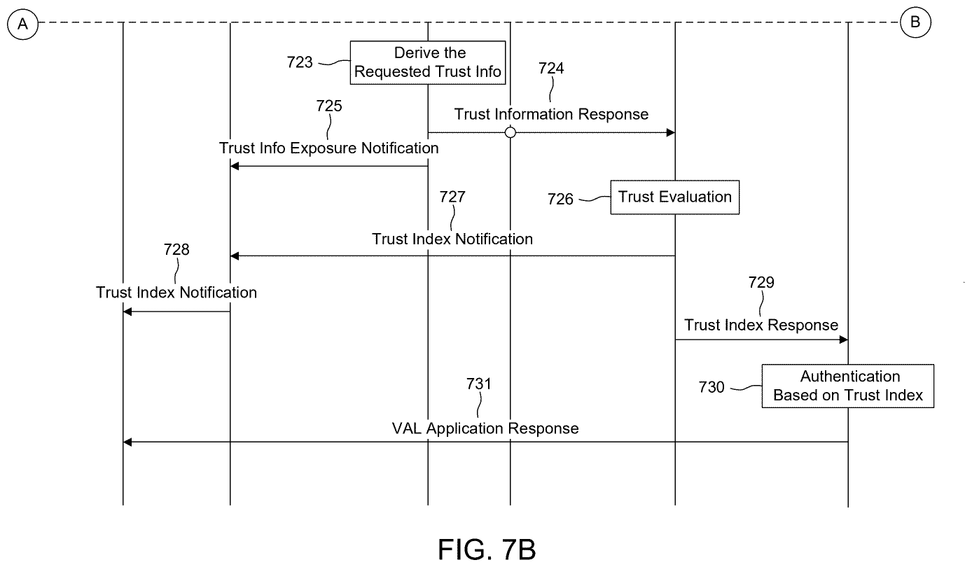

Referring now to FIGS. 7A-7B, a procedure for the TES to request extra and/or additional trust information of the VAL client and/or the WTRU from the iTMF is shown according to one or more embodiments. One or more entities, actors and/or logical NFs involved in this procedure include a VAL client 701 and its corresponding AEC, a TEC 702, a WTRU, an iTMF 703, an NEF 704, a TES 705, a VAL server 706 and its corresponding AES, and other NFs (e.g., a PCF, a NWDAF, and/or an AMF etc.).

At 711, similar to 311 of FIG. 3, in addition, the TEC 702 may have been provisioned with or discover the address of the TES 705. The TES 705 may be provisioned with the identifier or the address of the NEF 704. The VAL client 701 and/or its corresponding AEC may have been provisioned with the identifier or the address of the TEC 702. The VAL server 706 and/or its corresponding AES may have been provisioned with the identifier or the address of the TES 705. Each AEC on the WTRU may register with the TEC 702 using one or more of the following operations: the AEC may send an AEC registration request to the TEC 702; the AEC registration request may contain one or more of the following parameters: the identifier of the AEC; a list of identifiers of the VAL clients 701 that have been registered to the AEC or that are supported by the AEC; a list of identifiers, names, and/or types of source data that the AEC can collect and provide to the TEC 702; a list of identifiers, names, and/or types of source data that each VAL client 701 can collect and provide to the TEC 702; the willingness of the AEC and each of its VAL client for their trust information to be collected, measured, and/or evaluated by the TEC 702 and or the TES 705; the TEC 702 receives the AEC registration request, processes it, and creates an AEC profile; the AEC profile may contain all parameters received from the AEC registration request.

The TEC 702 may send an AEC registration response to the AEC. The AEC registration response may contain the identifier of the created AEC profile. The AEC registration response may also contain a list of identifiers, names, and/or types of data that the TEC 702 is interested in collecting from the AEC and/or the VAL client 701.

If the TEC 702 indicates to collect target data from the VAL client 701, the AEC may request the VAL client 701 to collect and report such target data to the AEC or directly to the TEC 702. The AEC may also send the identifier of the TEC 702 to the VAL client 701. Each AES may also register with the TES 705 using one or more of the following operations: the AES may send an AES registration request to the TES 705; the AES registration request may contain one or more of the following parameters: the identifier of the AES; a list of identifiers of the VAL server 706 that have been registered to the AES or that are supported by the AES; a list of identifiers, names, and/or types of source data that the AES can collect and provide to the TES 705; a list of identifiers, names, and/or types of source data that each VAL server 706 can collect and provide to the TES 705. The TES 705 may receive the AES registration request, processes it, and create an AES profile. The AES profile may contain all parameters received from the AES registration request.

The TES 705 may send an AES registration response to the AES. The AES registration response may contain the identifier of the created AES profile. The AES registration response may also contain a list of identifiers, names, and/or types of data that the TES 705 is interested in collecting from the AES and/or the VAL server 706.

If TES 705 indicates to collect some target data from the VAL server 706, the AES may request the VAL server 706 to collect and report such target data to the AES and/or directly to the TES 705. The AES may also send the identifier of the TES 705 to the VAL server 706.

At 712, the TEC 702 may generate the TEC registration request and may send it to the TES 705. The TEC registration request may include a TEC-ID indicative of an identifier of the TEC 702. The TEC registration request may include a TEC-Credential indicative of a credential of the TEC 702. The TEC registration request may include AEC-ID indicative of a list of identifiers of AECs which have been registered with the TEC 702. The TEC registration request may include VAL-Client-ID indicative of a list of identifiers of VAL clients which have been registered with each AEC. The TEC registration request may include UE-External-ID indicative of the external identifier of the WTRU (e.g., GPSI). The TEC registration request may include TEC-Trust-Capability indicative of the trust capability of the TEC 702. This parameter is similar to UETC-Container and may include the following parameters: a TEC-ID indicative of the identifier of the TEC 702; a UE-External-ID indicative of the external identifier of the WTRU; willingness of the trust information collection and measurement: the willingness of the TEC, AECs, and/or the VAL clients on their trust information to be collected, measured, and/or evaluated by the TES. The potential values of this parameter may be YES or NO for the TEC, each AEC, and/or each VAL client; willingness of the trust information exposure: the willingness of the TEC, AECs, and/or the VAL clients on their trust information to be exposed by the TES to other NFs and/or other domains. The potential values of this parameter may be YES or NO for the TEC, each AEC, and/or each VAL client. The TEC registration request may include an iTMF-ID indicative of the identifier of one or multiple iTMFs that the TES 705 can interact with to obtain extra trust information about the WTRU that hosts the TEC 702 and the VAL client 701. The TEC registration request may include one or more trust capabilities including a set of TEC capacities in collecting, measuring, storing, processing, and/or reporting the trust information of the TEC, the AESs, and the VAL clients and reporting the measured trust information to the TES 705. This trust capabilities may be described using a capability level, which may be various levels such as: trust information collection (to collect raw trust information), trust information evaluation (to process raw trust information to generate temporary or final trust index according to equations, methods, and/or functions as indicated by trust information evaluation formula etc.), trust information storage (to store raw and/or processed trust information for a time period as indicated by trust information Storage period etc.), trust information retrieval (the raw and/or processed trust information can or has to be retrieved via trust information retrieval API etc.), and/or trust information reporting (to report raw and/or processed trust information to the iTMF etc.).

The trust capabilities may include an app-ID indicative of the list of identifiers, names, and/or types of vertical applications that this trust capability is applied to. The trust capabilities may include trust information evaluation formula indicative of the equations, methods, and/or functions for the TEC to process collected raw trust information. The trust capabilities may include the trust information Storage period indicative of the time period (e.g., in minutes) indicating how long each piece of raw and/or processed trust information will be stored by the TEC. The trust capabilities may include trust information storage size indicative of the storage size (e.g., in megabyte) that the TEC can be used for storing raw and/or processed trust information. The trust capabilities may include trust information retrieval API including the API information of the TEC that the TES can use to retrieve raw and/or trust information from the TEC. The trust capabilities may include an object of trust capability including the identifier of the AEC, a VAL client, and/or an AES, whose trust information will be collected, processed, stored, and/or reported by the TEC. The trust capabilities include source data include a list of identifiers, names, and/or types of source data that “object of trust capability” can collect and report. The trust capabilities may include time limitation of trust capability indicating that the TEC may only have such trust capability in one or a set of specific time periods. The trust capabilities may include a location limitation of trust capability indicating that the TEC may only have such trust capability when the WTRU hosting the TEC is in certain physical locations or regions. The trust capabilities may include trust information exposure assistance capability indicative of the TEC's capability in providing trust information exposure assistance to the TEC when the TES sends a trust information exposure assistance request to the TEC. The trust capabilities may include trust information exposure approval capability indicative of the TEC's capability in verifying and approving a trust information exposure request that the iTMF may send to the TEC.

At 713, the TES 705 may receive the TEC registration request from the TEC 702. The TES may authenticate the request based on TEC-Credential. The authentication result may be APPROVED or REJECTED. If the authentication result is APPROVED, the TES 705 may create a TEC profile and assign a TEC profile identifier for it. The TEC profile may contain a subset, or the full set of parameters as received from 712. Then, the TES 705 may generate a TEC registration response and may send it to the TEC 702. The TEC registration response may contain the authentication status, the identifier of the created TEC profile, and/or trust evaluation instructions (TEI). A trust evaluation instruction may contain but not limited to the following parameters: TEI-ID indicative of the identifier of the trust evaluation instruction; Source-Data-ID indicative of a list of identifiers, names, and/or types of source data that the TEC, an AEC, and/or a VAL client can provide etc.; Evaluation-Formula indicative of a trust evaluation formula, equation and/or a function to be enforced on the source data; Evaluation-Frequency indicative of how the trust evaluation should be performed (e.g., once, periodically repeated, triggered by an event, etc.) based on Evaluation-Formula and source data; Evaluation-Result-Notification-Control indicative how the evaluation result should be notified (e.g., actively send to the TES, wait for the TES to retrieve, etc.); and/or the identifier of this VAL application request etc.

At 714, similar to 312 of FIG. 3, the VAL client 701 may send a VAL application request to the VAL server 706. This request may also contain the credential of the VAL client 701, the identifier of the VAL client 701, the external identifier of the WTRU hosting the VAL client 701, the identifier of the AEC that the VAL client 701 has registered to, the identifier of the TEC 702 that the AEC has registered to, and/or the identifier of the TES 705 that the TEC 702 has registered to.

At 715, the VAL server 706 may receive the VAL application request. For authenticating this request, the VAL server 706 may first verify the credential of the VAL client 701. For a stronger or trust-aware authentication, the VAL server 706 needs to obtain the trust index of the VAL client 701 (and optionally the trust index of the WTRU hosting the VAL client 701). The VAL server 706 may generate a trust index request and may send it to the TES 705. The trust index request may contain the identifier of the VAL application request, the credential of the VAL server 706, the identifier of the VAL server 706, the identifier of the AES that the VAL server 706 has registered to, and a subset or the full set of parameters received from 714. The trust index request may be sent to the TES 705 directly from the VAL server 706 to the TES 705 and/or relayed by the AES etc.

At 716, the TES 705 may receive the trust index request. It may first authenticate the VAL server 706 and/or the AES. Then, the TES 705 may perform an initial trust evaluation for the VAL client 701. If the initial trust evaluation cannot be fulfilled due to the lack of trust information of the WTRU hosting the VAL client 701 or the trust information of the WTRU is outdated or other reasons, the TES 705 may determine to obtain extra trust information about the WTRU.

If the TES does not know the identifier and/or the address of the iTMF 703 or the NEF 704, the TES 705 may use 717-718 to get some assistance from the WTRU; otherwise 717-718 may be skipped. Alternatively, the TES 705 may send a trust information exposure assistance request to a SEAL server, which may respond with a trust information exposure assistance response containing an address or an identifier of the iTMF 703.

At 717, the TES 705 may generate a trust information exposure assistance request and may send it to the TEC 702. The TES 705 can use the identifier of the VAL client 701 or the identifier of the AEC to look up local TEC profiles to find the TEC 702 which manages the VAL client 701 and the AEC and they all are on the same WTRU. The trust information exposure assistance request may include but is not limited to one or more of the following parameters: the identifier of the TES 705; the identifier of the VAL server 706; the identifier of the AES; the identifier of the VAL client 701; the identifier of the AEC; and/or the identifier of the VAL application request etc. The trust information exposure assistance request may also contain TINFO-ID, which indicate the identifier of the trust information about the WTRU and/or the VAL Client/AEC 701 that the TES needs to obtain in order to perform trust evaluation at 726.

At 718, the TEC may receive the trust information exposure assistance request. It may first verify if the indicated VAL client 701 and the AEC are valid and have been registered with the TEC 702. Then, the TEC 702 may generate a trust information exposure assistance response, which may contain the identifier of the iTMF 703 and/or the identifier of the NEF 704, the external identifier of the WTRU hosting the TEC 702. If the TEC 702 does not have the identifier of the iTMF 703 and/or the NEF 704, it may send a request to 3GPP domain (e.g., NRF) to obtain one or the TEC 702 may just indicate the identifier of the NRF (and/or other NFs) from which the TES 705 can find the iTMF 703 and/or the NEF 704. If the TEC 702 has the latest trust index of the WTRU that may have been signed by the iTMF 703, the TEC 702 may contain it in this response. If the latest trust index of the WTRU is valid (e.g., the signature of the iTMF 703 is valid) and meets the requirement of the TES 705 to evaluate the trust index of the VAL client 701, 719-725 may be skipped. Before 718, the TEC 702 may retrieve the trust information of WTRU and/or trust information of VAL Client/AEC 701 as indicated by TINFO-ID contained in 717 from iTMF 703; then the TEC 702 may contain such retrieved trust information in 718 and as a result, 719-724 may be skipped.

At 719, similar to 314-316 of FIG. 3, the TES 705 may generate and send trust information request to the NEF 704 that will forward the request to the iTMF 703. The trust information request may contain the credential of the TES 705, the identifier of the TES 705, a subset or the full set of parameters as received from the trust index request.

The processes at 720, 721, and 722 may be similar to 318, 319, and 320 of FIG. 3. If the iTMF 703 has the WTRU trust information exposure policy indicating that there is no need to get the instantaneous consent of the WTRU, 720-722 may be skipped.

At 723, similar to 321 of FIG. 3, the iTMF 703 may derive the trust information of the WTRU which hosts the VAL client 701. The iTMF 703 may also obtain the information about the PDU session that was established for the VAL client 701 and corresponding traffic information originated from or terminated at the VAL client 701 from the SMF (e.g., traffic volume during a time window, experienced delay, and/or experienced packet loss rate over the air interface etc.). Such PDU session information and traffic information of the VAL client 701 can be regarded as trust information of the VAL client 701 and be sent from the iTMF 703 to the TES 705 in 724.

At 724, similar to 322 and 324 of FIG. 3, the trust information may include but not limited to the trust information of the WTRU, the PDU session information of the VAL client 701, the traffic information of the VAL client 701, PCC rule information about the VAL client 701 etc.

The process of 725 may be similar 323 of FIG. 3.

At 726, similar to 325 of FIG. 3, the TES 705 may leverage the trust information received at 724 or at 718 to derive the final trust index of the VAL client 701.

At 727, the TES 705 may send a trust index notification to the TEC 702. The trust index notification may include the final trust index of the VAL client 701 as derived in 726, the signature of the TES 705. At 728, the TEC 702 may forward the trust index notification to the VAL client 701.

At 729, similar to 326 of FIG. 3. The TES 705 may generate a trust index response and may send it to the VAL server 706 directly or relayed by the AES. The trust index response includes the final trust index of the VAL client 701, the signature of the TES 705, the identifier of the VAL client 701.

At 730, the VAL server 706 continues to authenticate the VAL application request as received from 714 based on the final trust index of the VAL client 701. For example, if the final trust index is above a threshold, or within a range, the VAL server 706 marks the authentication result as APPROVED; otherwise, the authentication result may be REJECTED. If the authentication status is APPROVED, the VAL server 706 performs needed application tasks as requested in the VAL application request and may generate application result.

At 731, the VAL server 706 may generate a VAL application response and may send it to the VAL client 701. The VAL application response may include authentication result, application result, the identifier of the VAL server 706, the final trust index of the VAL client 701, and/or the threshold or the range that the VAL server 706 used 730.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
transmitting, to a first trust management function (TMF), a WTRU trust capability container indicative of one or more trust capabilities parameters;
creating one or more WTRU trust information exposure policies (TINFO-EPs);
transmitting the one or more TINFO-EPs to the first TMF;
transmitting, to an application server (AS), an application request comprising an identifier associated with the first TMF;
receiving, from the first TMF, a trust information exposure request in response to transmitting the application request;
approving or rejecting the trust information exposure request; and
transmitting, to the first TMF, a trust information exposure response indicative of the approval or the rejection of the trust information exposure request.

2. The method of claim 1, the method further comprising:
receiving, from a second TMF associated with the AS, an AS trust index associated with the AS;
comparing the AS trust index with a threshold AS trust index;
determining that the AS is trustworthy when the AS trust index exceeds the threshold AS trust index; and
establishing a protocol data unit (PDU) session based on determination that the AS is trustworthy.

3. The method of claim 2, wherein the first TMF is an internal TMF (iTMF) in a current public land mobile network (PLMN), and wherein the second TMF is an external TMF (eTMF) in a data network (DN) or a home PLMN.

4. The method of claim 2, wherein the WTRU trust capability container is transmitted using one or more of:
a WTRU registration request,
a service request,
a PDU session establishment request,
a PDU session modification request, or
a dedicated trust capability indication.

5. The method of claim 1, the method further comprising:
creating one or more new TINFO-EPs based on the trust information exposure request, wherein the trust information exposure response is further indicative of the one or more new TINFO-EPs.

6. The method of claim 5, the method further comprising:
receiving, from the first TMF, a trust information exposure notification indicative of updating the one or more new TINFO-EPs by the first TMF.

7. The method of claim 1, wherein the WTRU trust capability container is further indicative of one or more of:
willingness of trust information collection and measurement, or
willingness of trust information exposure.

8. The method of claim 1, wherein the one or more trust capabilities parameters include one or more of:
a trust capability level,
a trust information evaluation formula,
a trust information storage period,
a trust information storage size,
a trust information retrieval application programming interface (API),
an object of trust capability,
a time limitation associated with trust information capability,
a location limitation associated with the trust information capability, or
a trust information exposure approval capability.

9. The method of claim 1, wherein the one or more TINFO-EPs are indicative of one or more of:
one or more TINFO-EP application conditions,
one or more allowed external requesters,
one or more prohibited external requesters,
one or more WTRU consent conditions, or
a WTRU notification requirement.

10. The method of claim 1, wherein the application request is indicative of at least one of:
requesting one or more services from the AS, or
requesting discovery of one or more devices by the AS.

11. A wireless transmit/receive unit (WTRU), comprising:
a transceiver; and
a processor, wherein the transceiver and the processor are configured to:
transmit, to a first trust management function (TMF), a WTRU trust capability container indicative of one or more trust capabilities parameters,
create one or more WTRU trust information exposure policies (TINFO-EPs),
transmit the one or more TINFO-EPs to the first TMF,
transmit, to an application server (AS), an application request comprising an identifier associated with the first TMF,
receive, from the first TMF, a trust information exposure request in response to transmitting the application request,
approve or reject the trust information exposure request, and
transmit, to the first TMF, a trust information exposure response indicative of the approval or the rejection of the trust information exposure request.

12. The WTRU of claim 11, wherein the transceiver and the processor are configured to: receive, from a second TMF associated with the AS, an AS trust index associated with the AS,
compare the AS trust index with a threshold AS trust index;
determine that the AS is trustworthy when the AS trust index exceeds the threshold AS trust index; and
establish a protocol data unit (PDU) session based on determination that the AS is trustworthy.

13. The WTRU of claim 12, wherein the first TMF is an internal TMF (iTMF) in a current public land mobile network (PLMN), and wherein the second TMF is an external TMF (eTMF) in a data network (DN) or a home PLMN.

14. The WTRU of claim 12, wherein the WTRU trust capability container is transmitted using one or more of:
a WTRU registration request,
a service request,
a PDU session establishment request,
a PDU session modification request, or
a dedicated trust capability indication.

15. The WTRU of claim 11, wherein the transceiver and the processor are configured to:
create one or more new TINFO-EPs based on the trust information exposure request, wherein the trust information exposure response is further indicative of the one or more new TINFO-EPs.

16. The WTRU of claim 15, wherein the transceiver and the processor are configured to:
receive, from the first TMF, a trust information exposure notification indicative of updating the one or more new TINFO-EPs by the first TMF.

17. The WTRU of claim 11, wherein the WTRU trust capability container is further indicative of one or more of:
willingness of trust information collection and measurement, or
willingness of trust information exposure.

18. The WTRU of claim 11, wherein the one or more trust capabilities parameters include one or more of:
a trust capability level,
a trust information evaluation formula,
a trust information storage period,
a trust information storage size,
a trust information retrieval application programming interface (API),
an object of trust capability,
a time limitation associated with trust information capability,
a location limitation associated with the trust information capability, or
a trust information exposure approval capability.

19. The WTRU of claim 11, wherein the one or more TINFO-EPs are indicative of one or more of:
one or more TINFO-EP application conditions,
one or more allowed external requesters,
one or more prohibited external requesters,
one or more WTRU consent conditions, or
a WTRU notification requirement.

20. The WTRU of claim 11, wherein the application request is indicative of at least one of:
requesting one or more services from the AS, or
requesting discovery of one or more devices by the AS.
